(19) United States
(12) Patent Application Publication
(10) Pub. No.: US 2026/0320479 A1
(43) Pub. Date: Oct. 15, 2026

(54) SYSTEM AND METHOD FOR EVALUATING OPERATIONAL PERFORMANCE TO OPTIMIZE ARTIFICIAL INTELLIGENCE (AI) MODELS

(71) Applicant: SISA Information Security Pvt Ltd, Bengaluru (IN)

(72) Inventors: Anjan Krishnamurthy, Bangalore (IN); Renju Varghese, Bangalore (IN); Mahesh R, Bangalore (IN)

(21) Appl. No.: 19/177,790

(22) Filed: Apr. 14, 2025

(51) Int. Cl. G06N 20/00

(52) U.S. Cl. CPC G06N 20/00

(57) ABSTRACT

A system and method for evaluating operational performance to optimize artificial intelligence (AI) models is disclosed. The system utilizes a model functionality profiling subsystem to obtain structured information, a model evaluating subsystem to compute assurance scores, and an aggregate assurance score generating subsystem to assess AI model reliability, security, and compliance. A score validation subsystem performs comparative analysis using industry benchmarks, historical risk incidents, and expert-reviewed data. A compliance mapping subsystem detects deviations from AI compliance standards, while a dynamic control recommendation subsystem suggests mitigation strategies based on real-time model changes. The system includes a continuous monitoring subsystem for real-time performance tracking and adaptive compliance mapping. The system utilizes a weighted scoring procedure for AI risk assessment, ensuring automated, scalable, and adaptive AI governance across diverse deployment environments. The system enhances AI model transparency, security, fairness, and operational reliability while ensuring compliance with evolving regulatory standards.

### TECHNICAL FIELD

Embodiments of the present disclosure relate to artificial intelligence (AI) governance and risk management systems and more particularly relate to a computer-implemented system and a computer-implemented method for evaluating operational performance to optimize one or more artificial intelligence (AI) models.

### BACKGROUND

Artificial Intelligence (AI) has seen widespread adoption across industries, revolutionizing decision-making processes, automation, and predictive analytics. However, as AI models, particularly machine learning (ML) and large language models (LLMs), become more complex and integrated into critical applications such as healthcare, finance, and cybersecurity, their governance, reliability, and compliance present significant challenges. Organizations deploying AI systems often struggle with ensuring transparency, fairness, security, and regulatory compliance, leading to operational risks, unintended biases, and ethical concerns.

One of the primary challenges in AI governance is the lack of standardized frameworks to evaluate an AI model’s operational performance and risk factors throughout its lifecycle. Current methodologies often focus on isolated risk assessments, neglecting the continuous monitoring and adaptability required to maintain AI model integrity over time. Additionally, existing compliance measures are fragmented, requiring organizations to manually map AI risks to different industry regulations such as the EU AI Act, ISO 42001, OWASP, and MITRE ATLAS, leading to inconsistencies and compliance gaps.

Another major limitation in existing AI risk management practices is the inability to quantify and compare assurance parameters effectively. AI systems often exhibit issues like bias, security vulnerabilities, prompt injection risks, and inaccurate outputs, but there is no universally accepted method to assign a risk score that reflects an AI model’s trustworthiness and compliance status. While some frameworks use manual auditing or static benchmarks, they fail to capture real-time operational deviations, emerging vulnerabilities, or evolving regulatory requirements.

Moreover, many AI governance solutions lack a dynamic mechanism to recommend mitigation strategies. In traditional AI risk assessments, once an issue is identified, organizations must manually design and implement corrective actions, often without clear guidance on how different control mechanisms affect compliance and operational efficiency. This reactive approach increases the likelihood of non-compliance, operational failures, and reputational risks for businesses relying on AI-driven automation.

Lastly, continuous monitoring and the AI model optimization remain critical pain points in AI lifecycle management. Existing systems often lack an automated, real-time feedback loop that can detect changes in AI models, data sources, or external risk factors. Without continuous assessment, AI models deployed in production environments are susceptible to performance degradation, drift in model behavior, and increased exposure to adversarial attacks.

In the existing technology, a system for implementing a responsible AI common controls framework for AI governance is disclosed. The system utilizes a data connector, databases for storing AI controls and key performance indicators, and an administrator portal. It identifies AI models, applies algorithms to evaluate overall risk, generates scores for responsible AI metrics, and compiles these scores into a report for review and approval. While this existing system addresses some aspects of AI governance, it lacks several key features and capabilities compared to the disclosed system. The existing system does not specifically target Large Language Models (LLMs) or provide a comprehensive risk assessment framework for AI/ML models across their entire lifecycle. The existing system does not gather detailed information about the model's functionality, data sources, dependencies, and stakeholder responsibilities. The existing system lacks a structured approach for evaluating multiple risk dimensions such as transparency, toxicity, data privacy, and accessibility. The existing system does not offer dynamic mapping of risk assessments to various AI compliance standards.

There are various technical problems with the AI governance and risk management systems in the prior art. In the existing technology, the organizations face significant challenges in accurately assessing and mitigating risks associated with AI models across their entire lifecycle. The existing systems often lack the capability to comprehensively evaluate multiple assurance parameters such as bias, fairness, transparency, and security in a unified framework. Additionally, these existing systems struggle to adapt to the dynamic nature of AI models, which can evolve and change behavior over time, leading to potential undetected risks.

Therefore, there is a need for a system to address the aforementioned issues by providing a comprehensive, adaptive, and real-time AI governance and risk management framework. Such a system should be capable of evaluating multiple assurance parameters across various deployment environments, continuously monitoring AI model performance, and dynamically mapping risks to evolving compliance standards. The system should integrate advanced AI techniques for nuanced risk assessment, generate actionable recommendations for risk mitigation, and offer a unified platform for managing the entire lifecycle of AI models. Additionally, there is a need for a solution that can aggregate and normalize risk scores across different AI applications and use cases, enabling organizations to have a holistic view of their AI risk landscape and make informed decisions about AI deployment and governance.

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, a computer-implemented method for evaluating operational performance to optimize one or more artificial intelligence (AI) models is disclosed. In the first step, the computer-implemented method includes obtaining, by one or more hardware processors through a model functionality profiling subsystem, structured information associated with the one or more AI models from at least one of: one or more users and one or more internal frameworks. The structured information comprises at least one of: a) meta data comprising at least one of: functional information, intended application data, input data, and output data, associated with the one or more AI models from the one or more users, b) tooling information comprising at least one of: computer program frameworks, model training tools, a plurality of deployment infrastructures, monitoring tools, and third-party application programming interface (API) integrations used in at least one of: development, deployment, and operation, of the one or more AI models from at least one of: the one or more users and the one or more internal frameworks, c) technical information comprising at least one of: AI model architecture, underlying process, training methodologies, fine-tuning processes, hyperparameters, and dependency mappings relevant to functioning of the one or more AI models, d) resource allocation information comprising at least of: processor type, memory allocation, storage capacity, network bandwidth, graphics processing unit (GPU) usage, cloud deployment settings, on-premise deployment settings, and associated cost parameters required for training, inference, and operational execution of the one or more AI models, e) dependency mapping information comprising at least one of: internal dependencies including database connections, internal API, and proprietary datasets, and external dependencies including third-party API, cloud services, and open-source libraries used in the operational execution of the one or more AI models, f) data governance information comprising at least of: responsibility matrix data, and accountability structure data, and g) data usage information comprising at least of: data set inventories, and data governance controls.

In the next step, the computer-implemented method includes evaluating, by the one or more hardware processors through a model evaluating subsystem, assurance scores of one or more assurance parameters based on an intended functionality of the one or more AI models. The model evaluating subsystem is configured to use at least one of: one or more large language models (LLMs), one or more machine learning (ML) models, a retrieval-augmented generation (RAG) framework, a chain-of-thought reasoning framework, a comparative analysis procedure, and a semantic similarity analysis to evaluate the assurance scores of the one or more assurance parameters. The one or more assurance parameters comprise at least one of: bias parameters, fairness parameters, transparency parameters, privacy parameters, profanity parameters, security parameters, compliance parameters, accuracy parameters, reliability parameters, safety parameters, and accessibility parameters. The evaluation of the assurance scores comprising at least one of: a) determining a bias score using the one or more LLMs trained on biased datasets, based on an analysis of the biased datasets and the generated output data to identify statistical imbalances in decision-making, b) computing a fairness score as an inverse function of the bias score to quantify the one or more AI models ability to provide unbiased and equitable outcomes, c) computing a transparency score using at least one of: the retrieval-augmented generation (RAG) framework employing structured prompts, cosine similarity scoring, and token-based Shapley approximation to evaluate explainability, and the chain-of-thought reasoning framework to assess the output data generated by the one or more AI models to provide step-by-step justifications, d) identifying profanity data in the output data of the one or more AI models using the one or more machine learning (ML) models trained on pre-defined profanity data for generating a profanity score, e) evaluating a security score based on detection of vulnerabilities in the output data of the one or more AI models, at least one of: adversarial attacks, prompt injection risks, and unauthorized data exposure, using a security assessment framework, f) mapping the validated aggregate assurance score with at least one of: the one or more AI compliance standards to determine a compliance percentage, g) determining an accuracy score using a dual evaluation by the semantic similarity analysis to compare the output data of the one or more AI models against an expected output and an X-Encoder module configured to capture intricate contextual relationships between the input data and the output data of the one or more AI models, and h) computing a reliability score based on analyzing multiple response data generated for a single input data using at least one of: a sentence transformer model, a pairwise cosine similarity matrix. Further, evaluating the assurance scores of the one or more assurance parameters comprise: deploying the one or more AI models on the plurality of deployment infrastructures, including at least one of: on-premise servers, cloud-based platforms, edge computing devices, and hybrid environments, to assess the operational performance across the plurality of deployment infrastructures to evaluate the assurance scores of one or more assurance parameters consistently.

In the next step, the computer-implemented method includes generating, by the one or more hardware processors through an aggregate assurance score generating subsystem, an aggregate assurance score for the one or more AI models based on aggregating the assurance scores using weighted scoring procedures based on at least one of: severity and probability of deviations in the operational performance the one or more AI models. Generating the aggregate assurance score using the weighted scoring procedures further comprises: a) providing a weighted score to each assurance parameter of the one or more assurance parameters based on the severity and the probability of deviations in the operational performance of the one or more AI models, b) dynamically altering the weighted score of the one or more assurance parameters based on at least one of: the intended application, application domain, and real-time monitoring feedback of the one or more AI models, c) normalizing the weighted score of the one or more assurance parameters across the plurality of deployment infrastructures to perform a comparative evaluation to generate the aggregate assurance score, and d) categorizing the aggregate assurance score into a plurality of stages based on the predefined regulatory threshold scores to determine the operational performance of the one or more AI models.

In the next step, the computer-implemented method includes performing, by the one or more hardware processors through a score validation subsystem, a comparative analysis between the aggregate assurance score and at least one of: predefined industry benchmarks, historical risk incidents, and expert-reviewed threshold data to validate the generated aggregate assurance score. Performing the comparative analysis of the aggregate assurance score further comprises: a) determining degradation of the one or more AI models over a time period based on the comparative analysis between the aggregate assurance score and the predefined industry benchmarks using at least one of: drift detection models and variance analysis procedures, b) identifying inconsistencies in the assurance scores of one or more assurance parameters based on the comparative analysis between real-time assurance scores and the historical risk incidents, and c) obtaining the expert-reviewed threshold data from at least one of: the one or more users and one or more consultant experts to perform the comparative analysis between the aggregate assurance score and the expert-reviewed threshold data to validate the mapping of the aggregate assurance score to the one or more AI compliance standards.

In the next step, the computer-implemented method includes mapping, by the one or more hardware processors through a compliance mapping subsystem, the validated aggregate assurance score with one or more AI compliance standards to determine contrary compliance data based on deviations in the aggregate assurance score from predefined regulatory threshold scores.

In the next step, the computer-implemented method includes providing, by the one or more hardware processors through a dynamic control recommendation subsystem, one or more recommendation controls to the one or more users based on detected changes in at least one of: an AI model architecture, training data in real-time, to mitigate the determined contrary compliance data. The one or more recommendation controls comprise at least one of: design stage controls, development and training controls, deployment controls, monitoring and operational controls, and live fine-tuning controls, to mitigate the determined contrary compliance data.

In the next step, the computer-implemented method includes evaluating, by the one or more hardware processors through a continuous monitoring subsystem, the operational performance of the one or more AI models in real-time based on detection of updated structured information in the one or more AI models over a defined time period to optimize the one or more AI models. Evaluating the operational performance by the continuous monitoring subsystem further comprises: a) identifying the contrary compliance data across the one or more AI compliance standards to prioritize one or more compliance requirements based on the assurance scores of the one or more assurance parameters, b) generating an analysis data comprises at least one of: compliance deviations, remediation actions, and aggregate assurance score justifications of the one or more AI models, and c) adapting compliance mappings dynamically based on updated one or more AI compliance standards.

In accordance with an embodiment of the present disclosure, a computer-implemented system for evaluating the operational performance to optimize the one or more AI models is disclosed. The computer-implemented system comprises the one or more hardware processors and a memory unit. The memory unit operatively connected to the one or more hardware processors, wherein the memory unit comprises a set of computer-readable instructions in form of a plurality of subsystems, configured to be executed by the one or more hardware processors. The plurality of subsystems comprises the model functionality profiling subsystem, the model evaluating subsystem, the aggregate assurance score, the score validation subsystem, the compliance mapping subsystem, the dynamic control recommendation subsystem, and the continuous monitoring subsystem.

In another embodiment, the model functionality profiling subsystem is configured to obtain the structured information associated with the one or more AI models from at least one of: the one or more users and the one or more internal frameworks. The model evaluating subsystem is configured to evaluate assurance scores of the one or more assurance parameters based on an intended functionality of the one or more AI models using at least one of: the one or more LLMs, the one or more ML models, the RAG framework, the chain-of-thought reasoning framework, the comparative analysis procedure, and the semantic similarity analysis.

In yet another embodiment, the aggregate assurance score generating subsystem is configured to generate the aggregate assurance score for the one or more AI models based on aggregating the assurance scores using the weighted scoring procedures based on at least one of: the severity and probability of deviations in the operational performance the one or more AI models. The score validation subsystem is configured to perform the comparative analysis between the aggregate assurance score and at least one of: the predefined industry benchmarks, the historical risk incidents, and the expert-reviewed threshold data to validate the generated aggregate assurance score.

In yet another embodiment, the compliance mapping subsystem is configured to map the validated aggregate assurance score with the one or more AI compliance standards to determine the contrary compliance data based on deviations in the aggregate assurance score from predefined regulatory threshold scores. The dynamic control recommendation subsystem is configured to provide the one or more recommendation controls to the one or more users based on detected changes in at least one of: the AI model architecture, the training data in real-time, to mitigate the determined contrary compliance data. The continuous monitoring subsystem is configured to evaluate the operational performance of the one or more AI models in real-time based on detection of updated structured information in the one or more AI models over a defined time period for optimizing the one or more AI models.

In accordance with an embodiment of the present disclosure, a non-transitory computer-readable storage medium storing computer-executable instructions that, when executed by the one or more hardware processors, cause the one or more hardware processors to perform operations for evaluating the operational performance to optimize the one or more AI models is disclosed. The operations comprising: a) obtaining structured information associated with the one or more AI models from at least one of: the one or more users and the one or more internal frameworks, b) evaluating the assurance scores of the one or more assurance parameters based on the intended functionality of the one or more AI models using at least one of: the one or more large LLMs, the one or more ML models, the RAG framework, the chain-of-thought reasoning framework, the comparative analysis procedure, and the semantic similarity analysis, c) generating the aggregate assurance score for the one or more AI models based on aggregating the assurance scores using the weighted scoring procedures based on at least one of: the severity and the probability of deviations in the operational performance the one or more AI models, d) performing the comparative analysis between the aggregate assurance score and at least one of: the predefined industry benchmarks, the historical risk incidents, and the expert-reviewed threshold data to validate the generated aggregate assurance score, e) mapping the validated aggregate assurance score with the one or more AI compliance standards to determine the contrary compliance data based on deviations in the aggregate assurance score from the predefined regulatory threshold scores, f) providing the one or more recommendation controls to the one or more users based on detected the changes in at least one of: the AI model architecture, the training data in real-time, to mitigate the determined contrary compliance data, and g) evaluating the operational performance of the one or more AI models in real-time based on detection of updated structured information in the one or more AI models over a defined time period to optimize the one or more artificial intelligence (AI) models.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limited in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 illustrates an exemplary block diagram representation of a network architecture depicting a computer-implemented system for evaluating operational performance to optimize one or more artificial intelligence (AI) models, in accordance with an embodiment of the present disclosure;

FIG. 2A illustrates an exemplary block diagram representation of the computer-implemented system as shown in FIG. 1 for evaluating the operational performance to optimize the one or more AI models, in accordance with an embodiment of the present invention;

FIG. 2B illustrates an exemplary flow chart depicting the computer-implemented system for evaluating the operational performance to optimize the one or more AI models, in accordance with an embodiment of the present invention;

FIG. 3 illustrates an exemplary flowchart of a computer-implemented method for evaluating the operational performance to optimize the one or more AI models, in accordance with an embodiment of the present invention; and

FIG. 4 illustrates an exemplary block diagram representation of one or more server platforms for evaluating the operational performance to optimize the one or more AI models, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises… a" does not, without more constraints, preclude the existence of other devices, sub-systems, additional sub-modules. Appearances of the phrase "in an embodiment”, "in another embodiment" and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client or server computer system) configured by an application may constitute a “module” (or “subsystem”) that is configured and operated to perform certain operations. In one embodiment, the “module” or “subsystem” may be implemented mechanically or electronically, so a module include dedicated circuitry or logic that is permanently configured (within a special-purpose processor) to perform certain operations. In another embodiment, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed permanently configured (hardwired) or temporarily configured (programmed) to operate in a certain manner and/or to perform certain operations described herein.

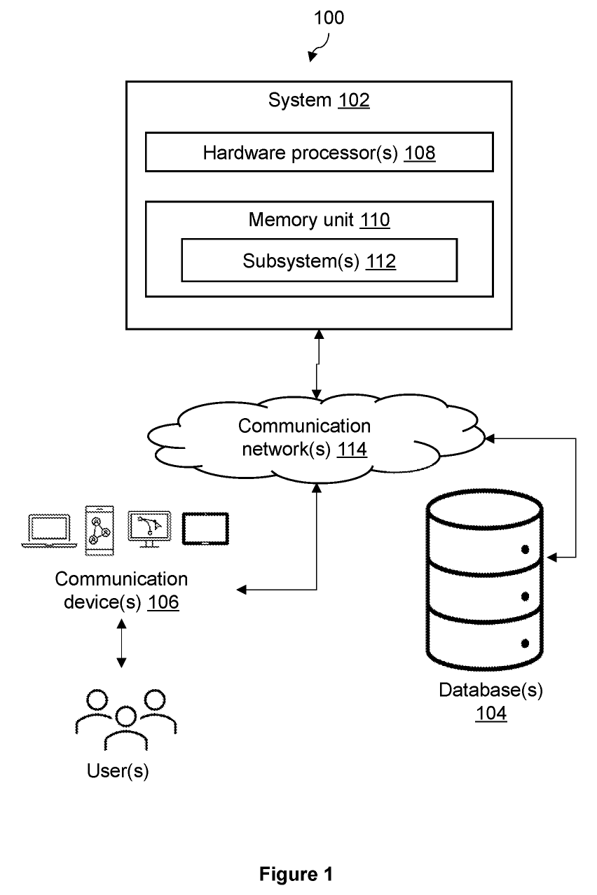

Referring now to the drawings, and more particularly to FIGS. 1 through 4, where similar reference characters denote corresponding features consistently throughout the figures, there are shown preferred embodiments, and these embodiments are described in the context of the following exemplary system and/or method.

FIG. 1 illustrates an exemplary block diagram representation of a network architecture 100 depicting a computer-implemented system 102 for evaluating operational performance to optimize one or more artificial intelligence (AI) models, in accordance with an embodiment of the present disclosure.

According to an exemplary embodiment of the present disclosure, FIG. 1 depicts the network architecture 100 may include the computer-implemented system 102, one or more databases 104, and one or more communication devices 106. The computer-implemented system 102 the one or more databases 104, and the one or more communication devices 106 may be communicatively coupled via one or more communication networks 114, ensuring seamless data transmission, processing, and decision-making. The computer-implemented system 102 acts as a central processing unit within the network architecture 100, responsible for evaluating operational performance to optimize one or more AI models. The computer-implemented system 102 is configured to execute a set of computer-readable instructions that control a plurality of subsystems 112.

In an exemplary embodiment, the computer-implemented system 102 is configured to evaluate the one or more AI models for assisting the deployment of the one or more AI models in an organizational environment. The computer-implemented system 102 is a structured Governance and Risk Assessment Framework tailored for the one or more AI models and the one or more ML models, especially one or more Large Language Models (LLMs). The computer-implemented system 102 provides a standardized, step-by-step process to identify, evaluate, and mitigate the diverse risks associated with deploying the one or more AI models in the organizational environment. By examining all aspects of the one or more AI models, its functionality, tools, data sources, roles and responsibilities, risk vectors, and suggesting controls at different AI model lifecycle stages, the computer-implemented system 102 ensures that decision-makers have a comprehensive overview of potential vulnerabilities, the controls needed to manage them effectively and allow organizations to easily map to required respective AI compliance policies.

In an exemplary embodiment, the computer-implemented system 102 comprises one or more servers. The one or more servers may comprise a combination of discrete components, an integrated circuit, an application-specific integrated circuit, a field-programmable gate array, a digital signal processor, or other suitable one or more hardware processors 108 and a software. The “software” may comprise one or more objects, agents, threads, lines of code, subroutines, separate software applications, two or more lines of code, or other suitable software structures operating in one or more software applications or the one or more hardware processors 108. The one or more servers comprises the one or more hardware processors 108 and a memory unit 110. The memory unit 110 is operatively connected to the one or more hardware processors 108. The memory unit 110 comprises a set of computer-readable instructions in form of a plurality of subsystems 112, configured to be executed by the one or more hardware processors 108.

In an exemplary embodiment, the one or more hardware processors 108 may include, for example, microprocessors, microcomputers, microcontrollers, digital signal processors, central processing units, state machines, logic circuits, and/or any devices that manipulate data or signals based on operational instructions. Among other capabilities, the one or more hardware processors 108 may fetch and execute computer-readable instructions in the memory unit 110 operationally coupled with the computer-implemented system 102 for performing tasks such as data processing, input/output processing, and/or any other functions. Any reference to a task in the present disclosure may refer to an operation being or that may be performed on data. The one or more hardware processors 108 is high-performance processors capable of handling large volumes of data and complex computations. The one or more hardware processors 108 may be, but not limited to, at least one of: multi-core central processing units (CPU), graphics processing units (GPUs), and specialized Artificial Intelligence (AI) accelerators that enhance an ability of the computer-implemented system 102 to process real-time data from one or more sources simultaneously.

In an exemplary embodiment, the one or more databases 104 may configured to store, and manage data related to various aspects of the computer-implemented system 102. The one or more databases 104 may store at least one of, but not limited to, structured information data, risk assessment data, compliance mapping data, model performance metrics, operational logs and monitoring data, control recommendations data, dependency and infrastructure data, user and role management data, and the like.

Additionally, the one or more databases 104 may store assurance scores, including a bias score, a fairness score, a transparency score, a profanity score, a security score, a compliance percentage, an accuracy score, and a reliability score, along with respected threshold scores and configuration settings necessary for generating performance reports. The one or more databases 104 enable the computer-implemented system 102 to dynamically retrieve, analyze, and update the stored data in real-time, facilitating continuous performance evaluation and optimization of the one or more generative AI models 120. The one or more databases 104 may include different types of databases such as, but not limited to, relational databases (e.g., Structured Query Language (SQL) databases), non-Structured Query Language (NoSQL) databases (e.g., MongoDB, Cassandra), time-series databases (e.g., InfluxDB), an OpenSearch database, and object storage systems (e.g., Amazon^{®} S3, PostgresDB).

In an exemplary embodiment, the one or more communication devices 106 are configured to provide the one or more AI models to the computer-implemented system 102 for evaluating operational performance. Additionally, the one or more communication devices 106 are configured to provide one or more recommendation controls 228 to the one or more users through a user interface. The one or more communication devices 106 may be digital devices, computing devices, and/or networks. The one or more communication devices 106 may include, but not limited to, a mobile device, a smartphone, a personal digital assistant (PDA), a tablet computer, a phablet computer, a wearable computing device, a virtual reality/augmented reality (VR/AR) device, a laptop, a desktop, and the like.

In an exemplary embodiment, the one or more communication devices 106 may be associated with, but not limited to, one or more service providers, one or more customers, an individual, an administrator, a vendor, a technician, a specialist, an instructor, a supervisor, a team, an entity, an organization, a company, a facility, a bot, any other user, and combination thereof. The entity, the organization, and the facility may include, but not limited to, an e-commerce company, online marketplaces, service providers, retail stores, a merchant organization, a logistics company, warehouses, transportation company, an airline company, a hotel booking company, a hospital, a healthcare facility, an exercise facility, a laboratory facility, a company, an outlet, a manufacturing unit, an enterprise, an organization, an educational institution, a secured facility, a warehouse facility, a supply chain facility, any other facility/organization and the like.

In an exemplary embodiment, the one or more communication networks 114 may be, but not limited to, a wired communication network and/or a wireless communication network, a local area network (LAN), a wide area network (WAN), a Wireless Local Area Network (WLAN), a metropolitan area network (MAN), a telephone network, such as the Public Switched Telephone Network (PSTN) or a cellular network, an intranet, the Internet, a fiber optic network, a satellite network, a cloud computing network, or a combination of networks. The wired communication network may comprise, but not limited to, at least one of: Ethernet connections, Fiber Optics, Power Line Communications (PLCs), Serial Communications, Coaxial Cables, Quantum Communication, Advanced Fiber Optics, Hybrid Networks, and the like. The wireless communication network may comprise, but not limited to, at least one of: wireless fidelity (wi-fi), cellular networks (including fourth generation (4G) technologies and fifth generation (5G) technologies), Bluetooth, ZigBee, long-range wide area network (LoRaWAN), satellite communication, radio frequency identification (RFID), 6G (sixth generation) networks, advanced IoT protocols, mesh networks, non-terrestrial networks (NTNs), near field communication (NFC), and the like.

In an exemplary embodiment, the computer-implemented system 102 may be implemented by way of a single device or a combination of multiple devices that may be operatively connected or networked together. The computer-implemented system 102 may be implemented in hardware or a suitable combination of hardware and software.

Though few components and the plurality of subsystems 112 are disclosed in FIG. 1, there may be additional components and subsystems which is not shown, such as, but not limited to, ports, routers, repeaters, firewall devices, network devices, the one or more databases 104, network attached storage devices, assets, machinery, instruments, facility equipment, emergency management devices, image capturing devices, any other devices, and combination thereof. The person skilled in the art should not be limiting the components/subsystems shown in FIG. 1. Although FIG. 1 illustrates the computer-implemented system 102, and the one or more communication devices 106 connected to the one or more databases 104, one skilled in the art can envision that the computer-implemented system 102, and the one or more communication devices 106 may be connected to several user devices located at various locations and several databases via the one or more communication networks 114.

Those of ordinary skilled in the art will appreciate that the hardware depicted in FIG. 1 may vary for particular implementations. For example, other peripheral devices such as an optical disk drive and the like, the local area network (LAN), the wide area network (WAN), wireless (e.g., wireless-fidelity (Wi-Fi)) adapter, graphics adapter, disk controller, input/output (I/O) adapter also may be used in addition or place of the hardware depicted. The depicted example is provided for explanation only and is not meant to imply architectural limitations concerning the present disclosure.

Those skilled in the art will recognize that, for simplicity and clarity, the full structure and operation of all data processing systems suitable for use with the present disclosure are not being depicted or described herein. Instead, only so much of the computer-implemented system 102 as is unique to the present disclosure or necessary for an understanding of the present disclosure is depicted and described. The remainder of the construction and operation of the computer-implemented system 102 may conform to any of the various current implementations and practices that were known in the art.

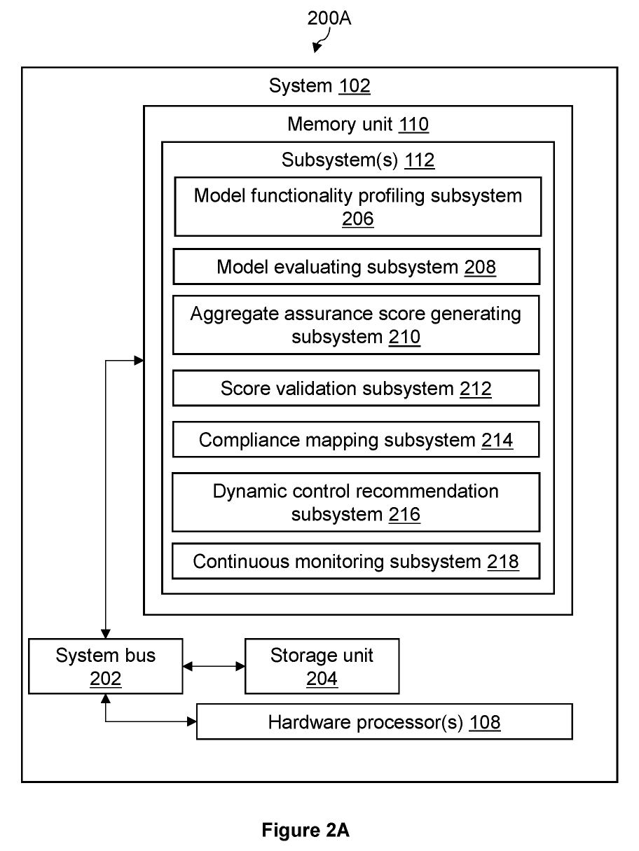

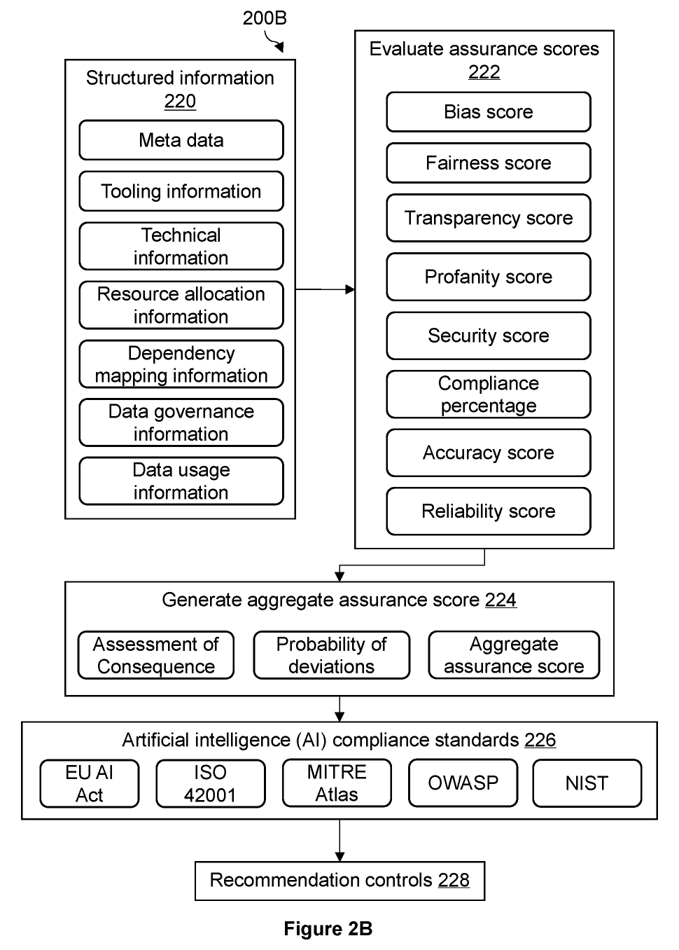

FIG. 2A illustrates an exemplary block diagram representation 200A of the computer-implemented system 102 as shown in FIG. 1 for evaluating the operational performance to optimize the one or more AI models, in accordance with an embodiment of the present invention.

FIG. 2B illustrates an exemplary flow chart 200B depicting the computer-implemented system 102 for evaluating the operational performance to optimize the one or more AI models, in accordance with an embodiment of the present invention.

In an exemplary embodiment, the computer-implemented system 102 (hereinafter referred to as the system 102) comprises the one or more servers, the memory unit 110, and a storage unit 204. The one or more hardware processors 108, the memory unit 110, and the storage unit 204 are communicatively coupled through a system bus 202 or any similar mechanism. The system bus 202 functions as the central conduit for data transfer and communication between the one or more hardware processors 108, the memory unit 110, and the storage unit 204. The system bus 202 facilitates the efficient exchange of information and instructions, enabling the coordinated operation of the system 102. The system bus 202 may be implemented using various technologies, including but not limited to, parallel buses, serial buses, or high-speed data transfer interfaces such as, but not limited to, at least one of a: universal serial bus (USB), peripheral component interconnect express (PCIe), and similar standards.

In an exemplary embodiment, the memory unit 110 is operatively connected to the one or more hardware processors 108. The memory unit 110 comprises the plurality of subsystems 112 in the form of programmable instructions executable by the one or more hardware processors 108. The plurality of subsystems 112 comprises a model functionality profiling subsystem 206, a model evaluating subsystem 208, an aggregate assurance score generating subsystem 210, a score validation subsystem 212, a compliance mapping subsystem 214, a dynamic control recommendation subsystem 216, and a continuous monitoring subsystem 218. The one or more hardware processors 108 associated within the one or more servers, as used herein, means any type of computational circuit, such as, but not limited to, the microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 108 may also include embedded controllers, such as generic or programmable logic devices or arrays, application-specific integrated circuits, single-chip computers, and the like.

The memory unit 110 may be the non-transitory volatile memory and the non-volatile memory. The memory unit 110 may be connected to communicate with the one or more hardware processors 108 and may serve as a computer-readable storage medium. The one or more hardware processors 108 may execute machine-readable instructions and/or source code stored in the memory unit 110. A variety of machine-readable instructions may be stored in and accessed from the memory unit 110. The memory unit 110 may include any suitable elements for storing data and machine-readable instructions, such as read-only memory, random access memory, erasable programmable read-only memory, electrically erasable programmable read-only memory, a hard drive, a removable media drive for handling compact disks, digital video disks, diskettes, magnetic tape cartridges, memory cards, and the like. In the present embodiment, the memory unit 110 includes the plurality of subsystems 112 stored in the form of machine-readable instructions on any of the above-mentioned storage media and may be in communication with and executed by the one or more hardware processors 108.

The storage unit 204 may be a cloud storage or the one or more databases 104 such as those shown in FIG. 1. The storage unit 204 may store, but not limited to, recommended course of action sequences dynamically generated by the system 102. These action sequences are based on at least one of, but not limited to, AI model risk assessments, comparative analysis results, compliance mapping and regulatory deviations, dynamic control adjustments, continuous monitoring feedback, deployment infrastructure considerations, adaptive governance strategies, and the like. The dynamically generated action sequences may be used to optimize the evaluation of the operational performance of the one or more AI models, improve response accuracy, enhance security protocols, or adjust the behavior of the system 102 to align with updated requirements or contexts. Additionally, the storage unit 204 may retain previous action sequences for comparison and future reference, enabling continuous refinement of the system 102 over time. The storage unit 204 may be any kind of database such as, but not limited to, relational databases, dedicated databases, dynamic databases, monetized databases, scalable databases, cloud databases, distributed databases, any other databases, and a combination thereof.

In an exemplary embodiment, the model functionality profiling subsystem 206 is configured to obtain the structured information 220 associated with the one or more AI models from at least one of: one or more users and one or more internal frameworks. The structured information 220 comprises, but not limited to, at least one of: meta data, tooling information, technical information, resource allocation information, dependency mapping information, data governance information, and data usage information, and the like. This structured information 220 plays a crucial role in enabling a comprehensive assessment of the one or more AI models operational performance, risk exposure, and compliance adherence, thereby ensuring informed governance and decision-making throughout the AI lifecycle.

The meta data comprises at least one of: functional information, intended application data, input data, and output data, associated with the one or more AI models from the one or more users. The functional information describes the core purpose, objectives, and intended usage of the one or more AI models, ensuring that the one or more AI models behavior aligns with its specified function. The intended application data outlines the domain or sector where the one or more AI models are deployed, such as healthcare, finance, cybersecurity, or general-purpose applications, which directly impacts the risk evaluation process. The input data includes the type, format, and sources of data that the AI model processes, while the output data defines the expected response or results generated by the model in real-world operational conditions.

The tooling information comprising at least one of: computer program frameworks, model training tools, a plurality of deployment infrastructures, monitoring tools, and third-party application programming interface (API) integrations used in at least one of: development, deployment, and operation, of the one or more AI models from at least one of: the one or more users and the one or more internal frameworks. The computer program frameworks refer to the software libraries, coding languages, and AI development environments used to design, build, and refine the one or more AI models, including but not limited to, at least one of: TensorFlow, PyTorch, Scikit-Learn, and proprietary model development frameworks. The model training tools encompass algorithms, datasets, and computational techniques utilized to train, fine-tune, and optimize the performance of the one or more AI models. The plurality of deployment infrastructures includes various environments where AI models are hosted and executed, such as cloud-based platforms (e.g., Amazon Web Services (AWS), Azure, Google Cloud), on-premise servers, edge computing devices, or hybrid deployments. The monitoring tools refer to mechanisms that track model performance, detect anomalies, and ensure compliance with predefined governance policies during the AI model’s operational phase. The third-party application programming interface (API) integrations include, but not limited to, at least one of: external services, tools, and platforms that the one or more AI models interacts with, which may introduce dependencies that need to be assessed for risk and compliance.

The technical information comprising at least one of: artificial intelligence (AI) model architecture, underlying process, training methodologies, fine-tuning processes, hyperparameters, and dependency mappings relevant to functioning of the one or more AI models. The AI model architecture describes the structural design of the one or more AI models, including neural network layers, decision trees, or other computational structures that define the one or more AI models learning and reasoning capabilities. The underlying process refers to the workflow mechanisms and procedures that drive model functionality, including supervised learning, unsupervised learning, reinforcement learning, and retrieval-augmented generation (RAG). The training methodologies include approaches such as transfer learning, continual learning, federated learning, and adversarial training, which impact the robustness and adaptability of the one or more AI models. The fine-tuning processes involve domain-specific adjustments to pre-trained models to enhance their accuracy and reliability for targeted applications. The hyperparameters refer to configuration settings such as learning rates, batch sizes, and activation functions that influence model performance and optimization. The dependency mappings detail the relationships between various model components, ensuring traceability and accountability in AI-driven decision-making.

The resource allocation information comprising at least of: processor type, memory allocation, storage capacity, network bandwidth, graphics processing unit (GPU) usage, cloud deployment settings, on-premise deployment settings, and associated cost parameters required for training, inference, and operational execution of the one or more AI models. The processor type indicates the computational architecture, including the CPUs and the GPUs, that drive computations of the one or more AI models. The memory allocation refers to the amount of a random access memory (RAM) and a cache memory dedicated for execution, influencing speed and scalability of the one or more AI models. The storage capacity includes disk space for storing datasets, model checkpoints, and logs, ensuring seamless AI training and deployment. The network bandwidth defines the communication efficiency between distributed AI model components, particularly for cloud-based and edge computing applications. The GPU usage specifies the allocation of high-performance computing resources, which is critical for deep learning and complex AI workloads. The cloud deployment settings define the configurations for hosting AI models in cloud environments, while on-premise deployment settings address security, access control, and infrastructure constraints for in-house model execution. The associated cost parameters provide an overview of financial considerations related to resource consumption, ensuring cost-effective AI model management.

The dependency mapping information comprising at least one of: internal dependencies including database connections, internal application programming interface (API), and proprietary datasets, and external dependencies including third-party API, cloud services, and open-source libraries used in the operational execution of the one or more AI models. The internal dependencies detail the one or more AI models reliance on organizational infrastructure, proprietary databases, and secured APIs, which influence data integrity and security. The external dependencies highlight interactions with third-party tools, cloud platforms, and publicly available datasets, which introduce additional compliance and security risks. Identifying these dependencies ensures that all interconnected elements within the AI model's operational framework are accounted for in the governance and risk assessment process.

The data governance information comprising at least of: responsibility matrix data, and accountability structure data. The responsibility matrix data defines the roles and responsibilities of various stakeholders involved in AI model development, deployment, monitoring, and governance, ensuring that decision-making processes are well-documented and auditable. The accountability structure data maps out hierarchical oversight mechanisms, tracking who is responsible for approving, reviewing, and mitigating AI model risks throughout its lifecycle.

The data usage information comprises at least of: data set inventories, and data governance controls. The data set inventories maintain a record of all datasets used for training, validation, and testing the one or more AI models, including data sources, licensing details, and quality metrics. The data governance controls enforce policies related to data privacy, security, and ethical AI usage, ensuring that the one or more AI models adhere to legal and regulatory requirements. This ensures that organizations maintain transparency, fairness, and accountability in AI-driven decision-making, minimizing risks related to biased outputs, data breaches, or unethical model behaviors.

In an exemplary embodiment, the model evaluating subsystem 208 is configured to evaluate the assurance scores 222 of one or more assurance parameters based on an intended functionality of the one or more artificial intelligence (AI) models using at least one of, but not limited to, the one or more LLMs, one or more ML models, a retrieval-augmented generation (RAG) framework, a chain-of-thought reasoning framework, a comparative analysis procedure, and a semantic similarity analysis, and the like. The one or more assurance parameters comprise at least one of, but not limited to, bias parameters, fairness parameters, transparency parameters, privacy parameters, profanity parameters, security parameters, compliance parameters, accuracy parameters, reliability parameters, safety parameters, accessibility parameters, and the like.

In an exemplary embodiment, the assurance scores 222 comprise at least one of: a bias score, a fairness score, a transparency score, a profanity score, a security score, a compliance percentage, an accuracy score, a reliability score, and the like. The bias score is determined by using the one or more LLMs trained on biased datasets, based on an analysis of the biased datasets and the output data to identify statistical imbalances in decision-making. The biased datasets refer to data collections that contain systematic distortions or imbalances that may lead the one or more AI model to produce unfair, discriminatory, or skewed outputs. Bias in datasets can arise from multiple sources, including historical inequalities, incomplete or non-representative data, labeling errors, and human prejudices. When the one or more AI models are trained on such datasets, they inherit and amplify these biases, resulting in outcomes that may favor certain groups over others or fail to perform equitably across different demographics. The fairness score is computed as an inverse function of the bias score to quantify the one or more AI models ability to provide unbiased and equitable outcomes.

The transparency score is computed using at least one of: a) the RAG framework employing structured prompts, cosine similarity scoring, and token-based Shapley approximation to evaluate explainability and b) the chain-of-thought reasoning framework to assess the output data generated by the one or more AI models to provide step-by-step justifications. The RAG framework enhances the explainability of the one or more AI model output data by incorporating external knowledge sources and structured prompts to generate responses that are more interpretable. The structured prompts are predefined or dynamically generated query formulations that guide the one or more AI models in retrieving and presenting relevant contextual information, ensuring that the AI-generated output aligns with the intended rationale. By employing structured prompts, the one or more AI models systematically breaks down its reasoning process, making it easier to trace the logical steps that led to a particular output. The cosine similarity scoring is utilized to measure the degree of alignment between the output data and the retrieved contextual information from the external knowledge base. This similarity measure is computed by representing both the retrieved context and the AI-generated response as vector embeddings and calculating the cosine of the angle between them. A higher cosine similarity score indicates a strong correlation between the one or more AI models response and the supporting information, enhancing the interpretability and transparency of the one or more AI models decision-making process. Conversely, a lower cosine similarity score suggests that the one or more AI models output data deviates from the retrieved knowledge, indicating a potential gap in explainability.

The token-based Shapley approximation is integrated into the transparency assessment to quantify the contribution of individual tokens or words in the AI-generated response to the overall output. This procedure applies cooperative game theory principles to determine the relative importance of each token in influencing the final decision of the one or more AI models. The Shapley approximation assigns a contribution value to each token based on its impact on the output data when included or excluded from the response. By analyzing these token-level contributions, the system 102 may identify which words or phrases have the most significant influence on the one or more AI models decision, thereby providing a granular level of transparency. This process allows the one or more users to understand why specific terms are emphasized and how they contribute to the output data.

The profanity score is generated by identifying profanity data in the output data of the one or more AI models using the one or more ML models trained on pre-defined profanity data. The profanity detection process involves analyzing the AI-generated output data to determine the presence of offensive, inappropriate, or harmful language based on a predefined profanity dataset. The predefined profanity dataset consists of an extensive lexicon of profane words, phrases, and contextual indicators that have been categorized based on severity, language, and cultural sensitivity. The one or more ML models used for profanity detection are trained on this dataset to recognize both explicit and implicit forms of profanity, ensuring comprehensive monitoring of AI-generated content. The one or more ML models utilize natural language processing (NLP) techniques such as tokenization, sequence modeling, and contextual embeddings to accurately detect profanity in structured and unstructured text. Tokenization breaks down the AI-generated output data into individual words or phrases, allowing the system to compare them against the predefined profanity dataset. Sequence modeling techniques, such as recurrent neural networks (RNNs) or transformer-based architectures, analyze the context in which a word or phrase appears to differentiate between benign and offensive usage. Contextual embeddings, such as word vector representations, enhance the profanity detection process by capturing the semantic relationships between words, thereby improving the accuracy of the profanity score. In addition to direct profanity detection, the system 102 incorporates techniques for identifying obfuscated profanity, where the one or more users attempt to bypass detection mechanisms by altering word spellings, inserting special characters, or using phonetic variations. The one or more ML models employ character-level and subword-based detection methods to recognize such modified profanity patterns and assign an appropriate profanity score. Furthermore, sentiment analysis and toxicity classification models are integrated to assess the overall tone of the AI-generated response, ensuring that the profanity detection mechanism is sensitive to contextually inappropriate expressions beyond explicit word-based profanity. The profanity score is computed based on the frequency, severity, and contextual relevance of detected profane content in the AI-generated output. Higher profanity scores indicate a greater presence of inappropriate language, triggering corrective actions such as content filtering, automatic redaction, or user alerts. Lower profanity scores signify minimal or no detected profanity, confirming the one or more AI models adherence to safe and appropriate language standards. By continuously refining the profanity detection process through adaptive ML model training and dataset expansion, the system ensures that AI-generated content remains aligned with ethical communication guidelines and regulatory compliance requirements.

The security score is evaluated based on detection of vulnerabilities in the output data of the one or more AI models, at least one of: adversarial attacks, prompt injection risks, and unauthorized data exposure, using a security assessment framework. The security assessment framework systematically evaluates the one or more AI models vulnerabilities by subjecting them to multiple risk scenarios and analyzing their output data to potential threats. The security assessment framework employs adversarial testing techniques, red teaming strategies, and automated security evaluations to measure the one or more AI models susceptibility to security risks. The adversarial attacks refer to intentionally crafted input modifications that manipulate the one or more AI models into producing incorrect or misleading output data. These attacks exploit weaknesses in the decision-making process of the one or more AI models, leveraging subtle perturbations in the input data that are imperceptible to humans but significantly impact the predictions of the one or more AI models. The security assessment framework detects adversarial attacks by employing adversarial training methods, anomaly detection techniques, and perturbation-based testing, ensuring the one or more AI models remains resilient against malicious manipulations. By systematically analyzing how the one or more AI models responds to adversarial inputs, the security assessment framework assigns a security score reflecting its robustness against such attacks. The prompt injection risks involve maliciously constructed input prompts designed to override AI model constraints, bypass security mechanisms, or manipulate the one or more AI models into generating unauthorized or harmful responses. These risks are particularly critical in one or more LLMs and conversational AI applications, where attackers craft adversarial prompts to extract confidential data, trigger biased outputs, or induce unethical behavior. The security assessment framework evaluates prompt injection risks by leveraging predefined attack test cases, employing similarity scoring functions with predetermined thresholds, and monitoring output deviations from expected safe responses. The framework maintains a dynamic database of known attack vectors, continuously updating its detection capabilities to account for emerging threats. A lower security score indicates increased susceptibility to prompt injection risks, triggering mitigation measures such as stricter input validation and reinforcement learning-based model adjustments.

The unauthorized data exposure occurs when the one or more AI models inadvertently reveals sensitive information, including personally identifiable information (PII), proprietary data, or confidential records. Such vulnerabilities may arise due to inadequate data sanitization, excessive model memorization, or improper compliance controls in the one or more AI models training and inference pipelines. The security assessment framework identifies unauthorized data exposure by implementing privacy-preserving techniques such as differential privacy, federated learning, and automated data redaction. The security assessment framework also employs rule-based heuristics, NLP models, and deep learning-based data leakage detection models to analyze AI-generated output data for signs of unintentional disclosure. The security assessment framework compares the output data against predefined compliance standards, ensuring the one or more AI models align with privacy regulations. The security score is computed by aggregating individual risk assessments from adversarial attack resilience, prompt injection resistance, and unauthorized data exposure analysis. The weighted scoring procedures are applied based on the severity, probability, and real-world impact of security vulnerabilities. A high security score indicates that the AI model demonstrates strong resilience against security threats, whereas a low score signifies increased exposure to adversarial risks, requiring immediate remediation measures. The security assessment framework continuously refines its evaluation criteria by integrating real-time monitoring feedback, historical risk assessments, and regulatory updates, ensuring the one or more AI models security remains adaptive to evolving threats and industry best practices.

The compliance percentage is determined by mapping the aggregate assurance score 224 that is validated with at least one of: the one or more AI compliance standards 226. The compliance percentage serves as a quantitative measure of the one or more AI models adherence to established regulatory, ethical, and industry-specific guidelines. The system 102 applies automated rule-based compliance mapping mechanisms, statistical alignment techniques, and machine learning-driven gap analysis to compare the assurance scores 222 associated with the one or more AI models with the predefined regulatory threshold scores. In cases where deviations from compliance requirements are detected, the system 102 flags areas of non-conformance and generates detailed reports highlighting the specific metrics that require improvement. The compliance percentage is normalized across different AI regulatory frameworks to ensure consistent evaluation, regardless of variations in compliance criteria across jurisdictions. A high compliance percentage indicates that the one or more AI models aligns well with regulatory standards, signifying minimal risk exposure and strong adherence to governance policies. Conversely, a low compliance percentage suggests potential compliance gaps, triggering remediation measures such as additional model auditing, retraining with ethically sourced datasets, enhancement of explainability mechanisms, or the implementation of stricter security controls. The compliance percentage also dynamically adjusts based on updates to AI regulatory frameworks, ensuring that the one or more AI models remain compliant with evolving legal and ethical guidelines.

The accuracy score is determined using a dual evaluation comprises a) the semantic similarity analysis to compare the output data of the one or more artificial intelligence (AI) models against an expected output, and b) an X-Encoder module configured to capture intricate contextual relationships between the input data and the output data of the one or more artificial intelligence (AI) models. The accuracy score serves as a quantitative measure of how closely the one or more AI models generated the output data aligned with expected results, ensuring that the one or more AI models produces output data that are both factually correct and contextually appropriate. The semantic similarity analysis is employed to assess the degree of alignment between the output data and the predefined expected output data. This analysis is conducted using vector-based embedding techniques, such as cosine similarity, to measure the distance between the semantic representations of the output data and the expected response. A high similarity score indicates that the one or more AI models output data closely matches the expected result in meaning and intent, whereas a lower similarity score suggests deviations that may compromise accuracy. The semantic similarity analysis ensures that even if the one or more AI models generate responses with slight variations in wording, it remains consistent with the intended message and factual correctness.

The X-Encoder module is utilized to further enhance the accuracy assessment by capturing intricate contextual relationships between the input data and the output data of the one or more AI models. Unlike traditional similarity measures that rely solely on surface-level text comparisons, the X-Encoder module employs deep contextual embeddings that analyze the relationships between different components of the input and output text. This enables the system 102 to evaluate whether the one or more AI models maintain logical coherence, preserves factual information, and appropriately contextualizes responses based on the given input. The X-Encoder module is particularly effective in scenarios where the one or more AI models generate complex, multi-step responses, ensuring that the one or more AI models reasoning remains consistent with the input data. The accuracy score is computed as the weighted combination of the semantic similarity score and the contextual relevance score derived from the X-Encoder module. A higher accuracy score signifies that the AI model produces responses that are not only factually correct but also contextually aligned with the input query. A lower accuracy score indicates discrepancies, which may arise due to misinterpretation of input data, hallucinated content, or inadequate training data coverage. By integrating both the semantic similarity analysis and the X-Encoder module, the system 102 ensures a comprehensive and robust evaluation of the one or more AI models accuracy, enabling continuous monitoring, iterative improvements, and real-time feedback for the one or more AI models optimization.

The reliability score is computed based on analyzing multiple response data generated for a single input data using at least one of: a sentence transformer model, a pairwise cosine similarity matrix. The reliability score serves as a key metric to assess the consistency and stability of the output data when presented with identical or similar input data. This ensures that the one or more AI models produces predictable and repeatable responses, reducing variations that may arise due to randomness, noise, or inconsistencies in one or more AI models inference. The sentence transformer model is employed to generate vector embeddings of multiple AI-generated responses for the same input data. The one or more AI models encodes textual responses into high-dimensional numerical representations, capturing the semantic meaning and contextual structure of each output data. By transforming responses into embeddings, the system 102 may effectively compare their similarity without being influenced by minor lexical variations. The final reliability score is computed by aggregating similarity values across multiple test cases and normalizing them against predefined stability thresholds. A higher reliability score signifies that the one or more AI models consistently generates similar output data for the same input, reinforcing trust in its predictability. A lower reliability score highlights inconsistencies, prompting further investigation into potential the one or more AI model weaknesses such as sensitivity to slight input perturbations, training biases, or deficiencies in response generation mechanisms.

The model evaluating subsystem 208 is configured to deploy the one or more AI models on the plurality of deployment infrastructures for assessing the operational performance across the plurality of deployment infrastructures to evaluate the assurance scores 222 of the one or more assurance parameters consistently. The plurality of deployment infrastructures include at least one of: on-premise servers, cloud-based platforms, edge computing devices, and hybrid environments. The model evaluating subsystem 208 ensures that the one or more AI models maintain consistent performance, reliability, and compliance across diverse computing environments by conducting real-time operational assessments and validation procedures tailored to each deployment setting. In on-premise server deployments, the model evaluating subsystem 208 monitors the one or more AI models within dedicated enterprise-controlled data centers, ensuring compliance with internal security policies, data governance standards, and latency-sensitive applications. This environment allows direct control over computational resources, making it ideal for organizations that require high-performance computing with strict data privacy regulations. The model evaluating subsystem 208 evaluates the one or more assurance parameters such as security, bias, fairness, and reliability by running model tests under controlled conditions, ensuring the model adheres to enterprise requirements. For cloud-based platforms, the model evaluating subsystem 208 integrates with the one or more AI models hosted on public, private, or multi-cloud environments, leveraging cloud-native services such as scalable compute instances, managed AI development tools, and distributed storage systems. Cloud-based AI models often rely on third-party infrastructure, requiring the model evaluating subsystem 208 to assess potential risks such as latency variations, data exposure, and cloud provider compliance alignment with regulatory standards such as General Data Protection Regulation (GDPR), International Organization for Standardization (ISO) 42001, and Open Web Application Security Project (OWASP) AI Security Guidelines. The model evaluating subsystem 208 dynamically monitors the one or more AI models performance, scaling, and security posture in cloud environments while continuously adjusting the assurance scores 222 based on real-time operational feedback. When deployed on edge computing devices, the model evaluating subsystem 208 assesses the one or more AI models operating in resource-constrained environments such as Internet of Things (IoT) devices, mobile applications, and embedded AI systems. Unlike centralized deployments, edge AI models must function with limited processing power, intermittent connectivity, and low-latency requirements. The model evaluating subsystem 208 evaluates the assurance scores 222 by testing the one or more AI models efficiency, real-time inference capabilities, and resilience against adversarial attacks in decentralized settings. Security assessments are critical in edge deployments, as models may be vulnerable to adversarial manipulations, unauthorized data extraction, and performance degradation due to hardware constraints. For the hybrid environments that combine on-premise, cloud-based, and edge computing deployments, the model evaluating subsystem 208 ensures that the assurance scores 222 are normalized across multiple infrastructures, enabling a consistent risk assessment framework regardless of where the AI model is executed. Hybrid deployments often involve dynamic workload distribution between different infrastructures, requiring the subsystem to continuously track operational deviations, assess AI model drift, and apply adaptive scoring mechanisms that reflect real-world deployment conditions. By deploying the one or more AI models across a plurality of deployment infrastructures, the model evaluating subsystem 208 provides a comprehensive assessment of AI performance, security, compliance, and reliability, ensuring that the one or more AI models remain trustworthy, scalable, and aligned with governance requirements across diverse execution environments.

In an exemplary embodiment, the aggregate assurance score generating subsystem 210 is configured to generate the aggregate assurance score 224 for the one or more AI models based on aggregating the assurance scores 222 using weighted scoring procedures based on at least one of: severity and probability of deviations in the operational performance the one or more AI models. The aggregate assurance score generating subsystem 210 ensures a standardized and quantifiable assessment of the one or more AI model performance by integrating the assurance scores 222 into a single composite score that reflects the overall trustworthiness, compliance, and reliability of the one or more AI models.

The aggregate assurance score generating subsystem 210 using the weighted scoring procedures to compute the aggregate assurance score 224. The weighted scoring procedures are configured to provide a weighted score for each assurance parameter of the one or more assurance parameters based on the severity and the probability of deviations in the operational performance of the one or more AI models. Each assurance parameter, such as at least one of: the bias parameters, the fairness parameters, the transparency parameters, the privacy parameters, the profanity parameters, the security parameters, the compliance parameters, the accuracy parameters, the reliability parameters, the safety parameters, and the accessibility parameters, is assigned a distinct weight that reflects its relative importance in the evaluation process. The severity of deviations is determined by analyzing the magnitude of risks posed by non-compliance or poor performance in each assurance category. The probability of deviations is assessed based on historical model performance, risk benchmarking, and real-time monitoring feedback, ensuring that frequently occurring deviations are appropriately weighted in the scoring mechanism.

The weighted scoring procedures are configured to dynamically alter the weighted score of the one or more assurance parameters based on at least one of: the intended application, application domain, and real-time monitoring feedback of the one or more AI models. Different AI applications have unique risk profiles; for example, an AI system used in healthcare demands higher accuracy and compliance than an AI model used for general-purpose text generation. Similarly, AI models in financial services must prioritize fairness and bias mitigation to prevent discriminatory decision-making. By dynamically adjusting the weighted scores based on domain-specific requirements, the aggregate assurance score generating subsystem 210 ensures that the aggregate assurance score 224 is contextualized for each AI model's operational environment. Additionally, real-time monitoring feedback allows for adaptive score adjustments as the one or more AI models evolve over time, reflecting changes in performance, compliance adherence, and risk exposure.

The weighted scoring procedures are configured to normalize the weighted score of the one or more assurance parameters across the plurality of deployment infrastructures to perform the comparative evaluation to generate the aggregate assurance score 224. The one or more AI models may be deployed on at least one of: the on-premise servers, the cloud-based platforms, the edge computing devices, and the hybrid environments, each of which introduces variations in performance and security risks. To ensure consistent evaluation, the weighted scoring procedures apply normalization techniques that adjust the assurance parameter scores relative to the specific deployment environment. This enables meaningful cross-platform comparisons and ensures that the aggregate assurance score 224 remains valid across different computing infrastructures.

The weighted scoring procedures are configured to categorize the aggregate assurance score 224 into a plurality of stages based on the predefined regulatory threshold scores to determine the operational performance of the one or more AI models. The categorization process involves mapping the generated aggregate assurance score 224 to established compliance thresholds, which may be defined by industry regulations, AI governance standards, or internal organizational policies. For example, an AI model with the aggregate assurance score 224 above a specified threshold may be classified as "Low Risk and Fully Compliant," while the AI model with a lower score may fall into "Moderate Risk – Requires Review" or "High Risk – Immediate Mitigation Needed" categories. These predefined regulatory threshold scores ensure that the one or more AI models are assessed consistently and transparently, allowing stakeholders to take appropriate governance actions based on the categorized risk levels. By leveraging dynamic weighting, deployment-aware normalization, and regulatory-driven categorization, the aggregate assurance score generating subsystem 210 provides a comprehensive and adaptable evaluation framework that enables organizations to monitor, assess, and improve the one or more AI models performance and compliance across diverse operational contexts.

In an exemplary embodiment, the score validation subsystem 212 is configured to perform the comparative analysis between the aggregate assurance score 224 and at least one of: predefined industry benchmarks, historical risk incidents, and expert-reviewed threshold data to validate the generated aggregate assurance score 224. The score validation subsystem 212 ensures that the generated aggregate assurance score 224 accurately reflects the operational performance and compliance of the one or more AI models by cross-referencing the computed scores with established benchmarks and historical performance records. The predefined industry benchmarks serve as reference thresholds derived from regulatory standards, industry best practices, and empirical studies that define acceptable AI model performance across different domains. The historical risk incidents consist of previously recorded AI model failures, deviations, and risk assessments that provide a baseline for identifying recurring performance degradation or emerging vulnerabilities. The expert-reviewed threshold data includes validation inputs from domain experts, auditors, and AI risk assessors, ensuring that the scoring system aligns with practical, real-world AI governance requirements.

The score validation subsystem 212 is configured to determine degradation of the one or more AI models over a time period based on the comparative analysis between the aggregate assurance score 224 and the predefined industry benchmarks using at least one of: drift detection models and variance analysis procedures. The one or more AI models are subject to performance drift, data drift, and concept drift, which may lead to progressive degradation in their reliability, accuracy, and compliance adherence over time. The score validation subsystem 212 employs drift detection models that continuously analyze the statistical distribution of AI-generated output data and compare them to historical data distributions. The drift detection models are machine learning techniques used to identify changes in data distributions over time that may affect the performance, reliability, and accuracy of the one or more AI models. The techniques involved in the drift detection models are statistical tests, moving average & control charts, embedding-based methods, online learning models, reconstruction-based approaches, and the like. Any significant deviation beyond an acceptable threshold signals potential model degradation, requiring corrective measures such as retraining or fine-tuning. The variance analysis procedures are utilized to assess fluctuations in the assurance scores 222 of the one or more AI models over time, ensuring that inconsistencies and gradual declines in performance are identified before they result in major failures or compliance breaches. By systematically monitoring drift and variance, the score validation subsystem 212 ensures that the one or more AI models maintain operational stability and long-term reliability.

The score validation subsystem 212 is configured to identify inconsistencies in the assurance scores 222 of one or more assurance parameters based on the comparative analysis between real-time assurance scores and the historical risk incidents. Each assurance parameter, such as, but not limited to, the bias parameters, the fairness parameters, the transparency parameters, the privacy parameters, the profanity parameters, the security parameters, the compliance parameters, the accuracy parameters, the reliability parameters, the safety parameters, and the accessibility parameters, is tracked in real time, and its historical trends are stored for reference. The score validation subsystem 212 compares the real-time assurance scores with past recorded scores to detect anomalies or unexpected variations. If an AI model previously demonstrated high fairness and low bias but suddenly exhibits an increased bias score, this signals a potential issue with recent model updates, training data modifications, or adversarial attacks. By identifying inconsistencies early, the score validation subsystem 212 enables proactive risk mitigation, preventing the one or more AI models from unintentionally introducing new compliance violations or operational failures.

The score validation subsystem 212 is configured to obtain the expert-reviewed threshold data from at least one of: the one or more users and the one or more consultant experts to perform the comparative analysis between the aggregate assurance score 224 and the expert-reviewed threshold data to validate the mapping of the aggregate assurance score 224 to the one or more AI compliance standards 226. The one or more AI compliance standards 226 comprise at least one of, but not limited to, European Union Artificial Intelligence Act (EU AI Act), ISO 42001, OWASP AI Security Guidelines, Massachusetts Institute of Technology Research and Engineering Adversarial Threat Landscape for Artificial-Intelligence Systems (MITRE ATLAS), and National Institute of Standards and Technology (NIST) AI Risk Management Framework, define different performance and risk assessment requirements. Since the one or more AI models behavior and risks are dynamic, periodic validation by expert reviewers ensures that the scoring system remains aligned with evolving regulatory, ethical, and security considerations. The score validation subsystem 212 collects expert feedback on the one or more AI models risk evaluations, ensuring that the assurance scores 222 and the generated aggregate assurance score 224 reflect realistic industry risks and compliance obligations. If discrepancies arise between computed scores and expert-reviewed thresholds, the system 102 recalibrates its evaluation metrics to maintain alignment with industry best practices and the one or more AI compliance standards 226. By integrating predefined benchmarks, historical risk comparisons, drift detection, variance analysis, real-time score validation, and expert feedback, the score validation subsystem 212 enhances the credibility, accuracy, and reliability of AI model risk assessments. This ensures that the one or more AI models continue to operate within acceptable risk thresholds while complying with regulatory frameworks and industry governance policies.

In an exemplary embodiment, the compliance mapping subsystem 214 is configured to map the aggregate assurance score 224 upon validation with the one or more AI compliance standards 226 to determine contrary compliance data based on deviations in the aggregate assurance score 224 from predefined regulatory threshold scores. The compliance mapping subsystem 214 ensures that the one or more AI models adhere to established regulatory, ethical, and industry-specific guidelines by evaluating the one or more AI models operational performance against predefined compliance frameworks. The mapping process involves aligning the validated aggregate assurance score 224 with the one or more AI compliance standards 226 such as the EU AI Act, ISO 42001, OWASP AI Security Guidelines, MITRE ATLAS, NIST AI Risk Management Framework, and other domain-specific AI governance policies. The one or more AI compliance standards 226 define the permissible risk thresholds and performance benchmarks that the one or more AI models must meet to be classified as compliant.

The compliance mapping subsystem 214 compares the validated aggregate assurance score 224 with predefined regulatory threshold scores that serve as compliance benchmarks for AI risk assessment. Each compliance standard establishes distinct requirements across key assurance parameters, including but not limited to, the bias parameters, the fairness parameters, the transparency parameters, the privacy parameters, the profanity parameters, the security parameters, the compliance parameters, the accuracy parameters, the reliability parameters, the safety parameters, and the accessibility parameters. The compliance mapping subsystem 214 analyzes how the assurance scores 222 of the one or more AI models align with the one or more AI compliance standards 226 and identifies any discrepancies that indicate a deviation from required regulatory standards. Deviations occur when the assurance scores 222 fall outside the acceptable risk range, indicating potential compliance violations, governance risks, or operational deficiencies.

The compliance mapping subsystem 214 is configured to generate contrary compliance data, which consists of detailed reports highlighting specific areas where the one or more AI models fail to meet regulatory criteria. The contrary compliance data provides a structured overview of non-conformance areas, risk severity levels, and the corresponding AI compliance standard requirements that have been violated. For instance, if the AI model exhibits a high bias score that exceeds the permissible limit defined under the EU AI Act, the contrary compliance data will indicate non-compliance with fairness and discrimination prevention mandates. Similarly, if the one or more AI models security score indicates vulnerabilities to adversarial attacks, the contrary compliance data will flag non-compliance with OWASP AI Security Guidelines.

The compliance mapping subsystem 214 enables automated risk categorization and regulatory gap analysis, ensuring that the AI models maintain compliance across multiple legal jurisdictions and industry-specific governance policies. By systematically mapping deviations in the aggregate assurance score 224 to compliance thresholds, the compliance mapping subsystem 214 allows organizations to identify, quantify, and mitigate AI-related risks in alignment with evolving regulatory landscapes. The compliance mapping subsystem 214 also facilitates dynamic updates based on regulatory changes, ensuring that the one or more AI models remain compliant as new AI governance policies and ethical standards emerge.

In an exemplary embodiment, the dynamic control recommendation subsystem 216 is configured to provide the one or more recommendation controls 228 to the one or more users based on detected changes in at least one of: an AI model architecture, training data in real-time, to mitigate the determined contrary compliance data. The dynamic control recommendation subsystem 216 functions as an adaptive AI governance mechanism that continuously monitors modifications in the one or more AI models, evaluates the impact of these modifications on compliance adherence, and dynamically suggests corrective measures to align AI operations with regulatory requirements and industry best practices.

The dynamic control recommendation subsystem 216 actively tracks changes in AI model architecture, including modifications to neural network structures, model adjustments, hyperparameter tuning, model optimization techniques, and integration of external AI components. Changes in the AI model architecture may significantly impact key the one or more assurance parameters. When the system 102 detects architectural updates that introduce performance deviations or compliance risks, the dynamic control recommendation subsystem 216 generates real-time recommendations to ensure that AI model modifications do not compromise adherence to the one or more AI compliance standards 226.

The dynamic control recommendation subsystem 216 also monitors training data in real-time to assess the impact of data variations, new dataset integrations, fine-tuning processes, and data pre-processing adjustments on the AI model performance. The one or more AI models are highly sensitive to training data distribution shifts, which may lead to unintended consequences such as bias amplification, reduced transparency, and security vulnerabilities. The dynamic control recommendation subsystem 216 evaluates how real-time data changes affect the validated aggregate assurance score 224 and provides recommendations to mitigate detected compliance deviations.

The one or more recommendation controls 228 comprise at least one of: design stage controls, development and training controls, deployment controls, monitoring and operational controls, and live fine-tuning controls, to mitigate the determined contrary compliance data. The design stage controls are recommended during the early phases of AI model development, ensuring that AI governance principles are embedded into the one or more AI models architecture before training. These controls focus on model fairness, explainability techniques, ethical AI considerations, and proactive bias mitigation strategies. The development and training controls include recommendations for dataset balancing, adversarial training techniques, privacy-preserving model development, and compliance-aware model training methodologies. These controls facilitate refine the one or more AI models to prevent risks such as bias drift, fairness violations, and security flaws that may arise during training.

The deployment controls focus on ensuring that the one or more AI models maintain regulatory compliance during real-world deployment across the on-premise, the cloud-based, the edge computing, and the hybrid infrastructures. The deployment controls include runtime security measures, input-output validation mechanisms, adversarial robustness testing, and real-time compliance validation to prevent operational risks, adversarial attacks, and unauthorized data exposure. Monitoring and operational controls ensure continuous oversight of AI model performance, enabling automated risk detection, regulatory updates adaptation, and real-time alerting of compliance deviations. The deployment controls are crucial for maintaining long-term AI governance and preventing gradual model degradation.

The live fine-tuning controls provide adaptive remediation mechanisms that enable the one or more AI models to adjust dynamically in response to evolving compliance requirements and operational risks. The live fine-tuning controls include automated risk mitigation feedback loops, reinforcement learning-based corrective actions, and compliance-aware adaptive retraining strategies. By implementing live fine-tuning controls, the system 102 ensures that the one or more AI models remain compliant even as new risk scenarios, adversarial techniques, and regulatory changes emerge. By leveraging a multi-tiered control recommendation framework, the dynamic control recommendation subsystem 216 ensures that the one or more AI models maintain compliance, security, fairness, and operational stability throughout their lifecycle. This proactive approach to AI governance enables organizations to minimize compliance violations, reduce operational risks, and uphold ethical AI principles while deploying the one or more AI models across diverse environments.

In an exemplary embodiment, the continuous monitoring subsystem 218 is configured to evaluate the operational performance of the one or more AI models in real-time based on detection of updated structured information in the one or more AI models over a defined time period for optimizing the one or more AI models. The continuous monitoring subsystem 218 is configured to provide automated, real-time tracking and assessment of the one or more AI models by continuously collecting, analyzing, and updating structured information related to AI model performance, compliance adherence, and risk exposure. By detecting and analyzing updates in the structured information 220 over a defined time period, the continuous monitoring subsystem 218 enables the one or more AI models to undergo continuous evaluation, iterative improvements, and adaptive risk mitigation, ensuring their sustained efficiency, accuracy, fairness, and compliance in dynamic operational environments.

The continuous monitoring subsystem 218 is configured to identify the contrary compliance data across the one or more AI compliance standards 226 to prioritize one or more compliance requirements based on the assurance scores 222 of the one or more assurance parameters. The one or more AI models are subject to evolving compliance obligations as regulatory frameworks and ethical AI principles are updated to address emerging risks, adversarial threats, data privacy concerns, and fairness considerations. The continuous monitoring subsystem 218 continuously compares the real-time assurance scores against the one or more artificial intelligence (AI) compliance standards 226, including but not limited to the EU AI Act, ISO 42001, OWASP AI Security Guidelines, MITRE ATLAS, and NIST AI Risk Management Framework. Any deviations from these benchmarks generate contrary compliance data, which highlights specific areas where the one or more AI models are non-compliant or at risk of non-compliance. The continuous monitoring subsystem 218 prioritizes compliance requirements based on the severity of deviations, the likelihood of regulatory violations, and the potential impact on AI model governance. The one or more AI models with high-risk deviations receive immediate compliance alerts and remediation recommendations, ensuring that governance teams may take corrective actions in a timely manner.

The continuous monitoring subsystem 218 is configured to adapt compliance mappings dynamically based on updated one or more AI compliance standards 226. Regulatory landscapes governing the one or more AI models are constantly evolving as new ethical guidelines, security policies, and fairness mandates are introduced. Static compliance frameworks fail to accommodate these changes, leading to potential non-compliance issues. To address this, the continuous monitoring subsystem 218 dynamically updates compliance mappings by incorporating new regulatory requirements, risk evaluation methodologies, and AI governance policies into the existing compliance framework. This adaptation process ensures that the one or more AI models remain aligned with current compliance mandates, reducing the risk of governance failures and regulatory penalties. The continuous monitoring subsystem 218 utilizes automated regulatory updates, industry benchmarking comparisons, and expert-reviewed compliance adjustments to refine its mapping mechanisms. As a result, organizations deploying the one or more AI models may ensure continuous adherence to evolving compliance requirements without manual intervention. By integrating real-time performance monitoring, compliance deviation detection, and dynamic regulatory adaptation, the continuous monitoring subsystem 218 provides a comprehensive AI governance framework that enables organizations to deploy trustworthy, ethical, and legally compliant the one or more AI models across diverse operational landscapes.

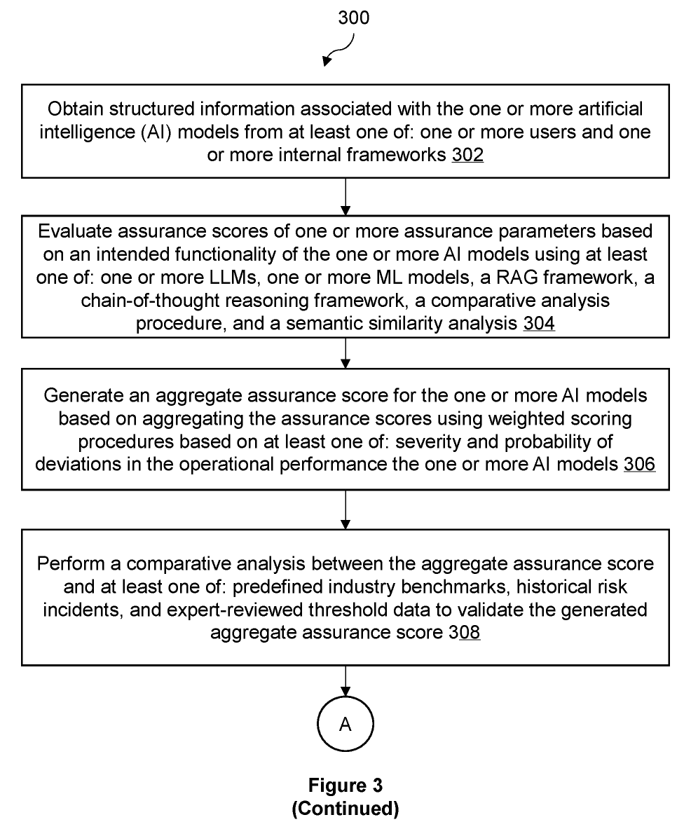

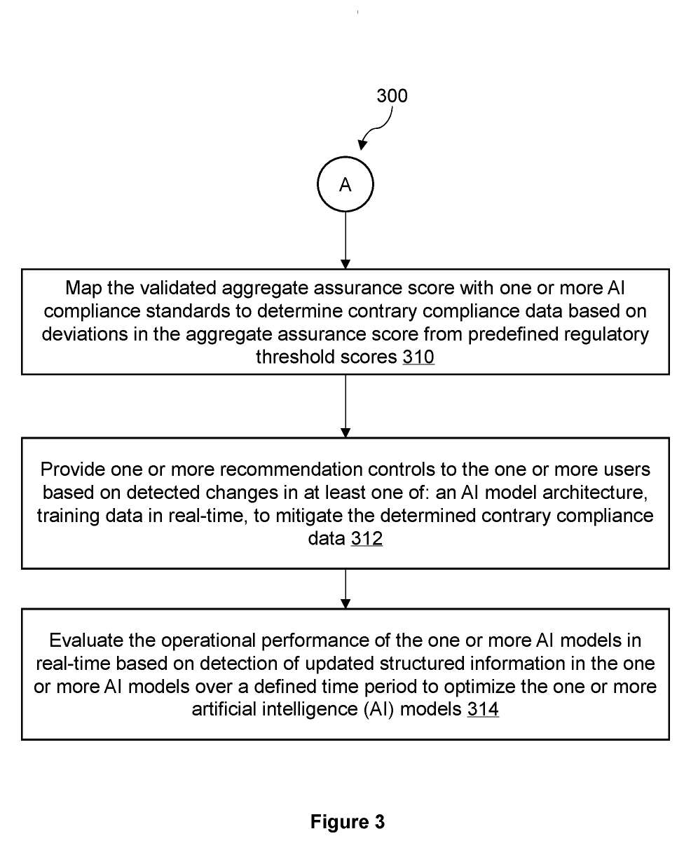

FIG. 3 illustrates an exemplary flowchart of a computer-implemented method 300 for evaluating the operational performance to optimize the one or more AI models, in accordance with an embodiment of the present invention.

In accordance with another embodiment of the present disclosure, the computer-implemented method 300 for evaluating operational performance to optimize the one or more AI models is disclosed. At step 302, the computer-implemented method 300 includes obtaining, by the one or more hardware processors through the model functionality profiling subsystem, the structured information associated with the one or more AI models from at least one of: the one or more users and the one or more internal frameworks. The structured information comprises at least one of: the meta data, the tooling information, the technical information, the resource allocation information, the dependency mapping information, the data governance information, and the data usage information, and the like.

At step 304, the computer-implemented method 300 includes evaluating, by the one or more hardware processors through the model evaluating subsystem, the assurance scores of the one or more assurance parameters based on the intended functionality of the one or more AI models. The model evaluating subsystem is configured to use at least one of: the one or more LLMs, the one or more ML models, the RAG framework, the chain-of-thought reasoning framework, the comparative analysis procedure, and the semantic similarity analysis to evaluate the assurance scores of the one or more assurance parameters. The one or more assurance parameters comprise, but not limited to, at least one of: the bias parameters, the fairness parameters, the transparency parameters, the privacy parameters, the profanity parameters, the security parameters, the compliance parameters, the accuracy parameters, the reliability parameters, the safety parameters, the accessibility parameters, and the like. The evaluation of the assurance scores comprising at least one of: the bias score, the fairness score, the transparency score, the profanity score, the security score, the compliance percentage, the accuracy score, the reliability score, and the like. Further, evaluating the assurance scores of the one or more assurance parameters comprise: deploying the one or more AI models on the plurality of deployment infrastructures, including at least one of: the on-premise servers, the cloud-based platforms, the edge computing devices, and the hybrid environments, to assess the operational performance across the plurality of deployment infrastructures to evaluate the assurance scores of the one or more assurance parameters consistently.

At step 306, the computer-implemented method 300 includes generating, by the one or more hardware processors through the aggregate assurance score generating subsystem, the aggregate assurance score for the one or more AI models based on aggregating the assurance scores using the weighted scoring procedures based on at least one of: the severity and the probability of deviations in the operational performance the one or more AI models. Generating the aggregate assurance score using the weighted scoring procedures further comprises: a) providing the weighted score to each assurance parameter of the one or more assurance parameters based on the severity and the probability of deviations in the operational performance of the one or more AI models, b) dynamically altering the weighted score of the one or more assurance parameters based on at least one of: the intended application, application domain, and real-time monitoring feedback of the one or more AI models, c) normalizing the weighted score of the one or more assurance parameters across the plurality of deployment infrastructures to perform the comparative evaluation to generate the aggregate assurance score, and d) categorizing the aggregate assurance score into the plurality of stages based on the predefined regulatory threshold scores to determine the operational performance of the one or more AI models.

At step 308, the computer-implemented method 300 includes performing, by the one or more hardware processors through the score validation subsystem, the comparative analysis between the aggregate assurance score and at least one of: the predefined industry benchmarks, the historical risk incidents, and the expert-reviewed threshold data to validate the generated aggregate assurance score. Further, performing the comparative analysis of the aggregate assurance score comprises: a) determining degradation of the one or more AI models over the time period based on the comparative analysis between the aggregate assurance score and the predefined industry benchmarks using at least one of: the drift detection models and the variance analysis procedures, b) identifying inconsistencies in the assurance scores of the one or more assurance parameters based on the comparative analysis between the real-time assurance scores and the historical risk incidents, and c) obtaining the expert-reviewed threshold data from at least one of: the one or more users and the one or more consultant experts to perform the comparative analysis between the aggregate assurance score and the expert-reviewed threshold data to validate the mapping of the aggregate assurance score to the one or more AI compliance standards.

At step 310, the computer-implemented method 300 includes mapping, by the one or more hardware processors through the compliance mapping subsystem, the validated aggregate assurance score with the one or more AI compliance standards to determine contrary compliance data based on deviations in the aggregate assurance score from predefined regulatory threshold scores. The one or more AI compliance standards, such as, but not limited to, at least one of: the EU AI Act, ISO 42001, OWASP AI Security Guidelines, MITRE ATLAS, NIST AI Risk Management Framework, and the like.

At step 312, the computer-implemented method 300 includes providing, by the one or more hardware processors through the dynamic control recommendation subsystem, the one or more recommendation controls to the one or more users based on the detected changes in at least one of: the AI model architecture, training data in real-time, to mitigate the determined contrary compliance data. The one or more recommendation controls comprise at least one of: the design stage controls, the development and training controls, the deployment controls, the monitoring and operational controls, and the live fine-tuning controls, to mitigate the determined contrary compliance data.

At step 314, the computer-implemented method 300 includes evaluating, by the one or more hardware processors through the continuous monitoring subsystem, the operational performance of the one or more AI models in real-time based on the detection of updated structured information in the one or more AI models over the defined time period to optimize the one or more AI models. Evaluating the operational performance by the continuous monitoring subsystem further comprises: a) identifying the contrary compliance data across the one or more AI compliance standards to prioritize one or more compliance requirements based on the assurance scores of the one or more assurance parameters, b) generating the analysis data comprises at least one of: the compliance deviations, the remediation actions, and the aggregate assurance score justifications of the one or more AI models, and c) adapting compliance mappings dynamically based on the updated one or more AI compliance standards.

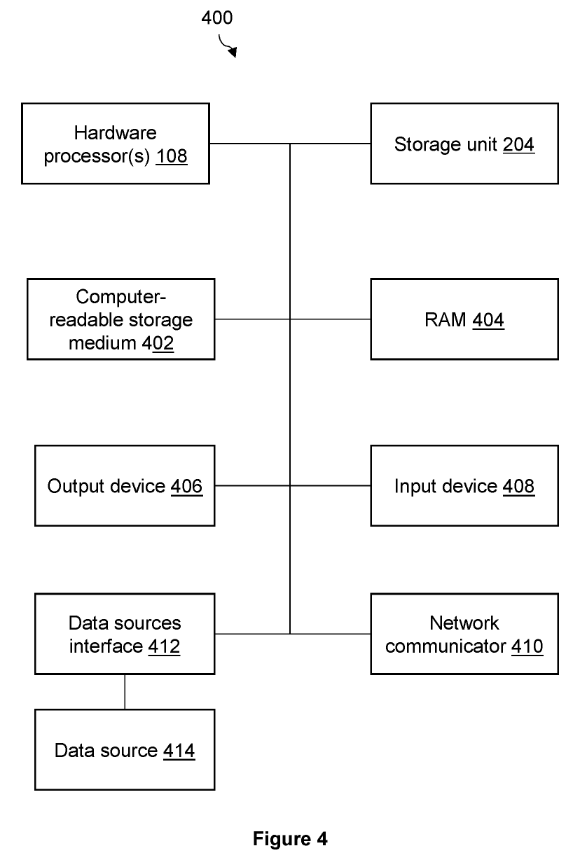

FIG. 4 illustrates an exemplary block diagram representation of one or more server platforms 400 for evaluating the operational performance to optimize the one or more AI models, in accordance with an embodiment of the present disclosure.

In an exemplary embodiment, for the sake of brevity, the construction, and operational features of the system 102 which are explained in detail above are not explained in detail herein. Particularly, computing machines such as but not limited to internal/external server clusters, quantum computers, desktops, laptops, smartphones, tablets, and wearables may be used to execute the system 102 or may include the structure of the one or more server platforms 400. As illustrated, the one or more server platforms 400 may include additional components not shown, and some of the components described may be removed and/or modified. For example, a computer system with the multiple graphics processing units (GPUs) may be located on at least one of: internal printed circuit boards (PCBs) and external-cloud platforms including the Amazon Web Services (AWS), Google Cloud Platform (GCP) Microsoft Azure (Azure), internal corporate cloud computing clusters, or organizational computing resources.

The one or more server platforms 400 may be a computer system such as the system 102 that may be used with the embodiments described herein. The computer system may represent a computational platform that includes components that may be on the one or more servers or another computer system. The computer system may be executed by the one or more hardware processors 108 (e.g., single, or multiple processors) or other hardware processing circuits, the methods, functions, and other processes described herein. These methods, functions, and other processes may be embodied as machine-readable instructions stored on a computer-readable medium, which may be non-transitory, such as hardware storage devices (e.g., RAM (random access memory), ROM (read-only memory), EPROM (erasable, programmable ROM), EEPROM (electrically erasable, programmable ROM), hard drives, and flash memory). The computer system may include the one or more hardware processors 108 that execute software instructions or code stored on a non-transitory computer-readable storage medium 402 to perform methods of the present disclosure. The software code includes, for example, instructions to gather data and analyze the network environment data. For example, the plurality of subsystems 112 consists of the model functionality profiling subsystem 206, the model evaluating subsystem 208, the aggregate assurance score generating subsystem 210, the score validation subsystem 212, the compliance mapping subsystem 214, the dynamic control recommendation subsystem 216, and the continuous monitoring subsystem 218.

The instructions on the computer-readable storage medium 402 are read and store the instructions in the storage unit or random-access memory (RAM) 404. The storage unit 204 may provide a space for keeping static data where at least some instructions could be stored for later execution. The stored instructions may be further compiled to generate other representations of the instructions and dynamically stored in the RAM 404. The one or more hardware processors 108 may read instructions from the RAM 404 and perform actions as instructed.

The computer system may further include an output device 406 to provide at least some of the results of the execution as output including, but not limited to, visual information of the performance reports to the one or more users. The output device 406 may include a display on computing devices and virtual reality glasses. For example, the display may be a mobile phone screen or a laptop screen. GUIs and/or text may be presented as an output on the display screen. The computer system may further include an input device 408 to provide the one or more users or another device with mechanisms for entering data and/or otherwise interacting with the computer system. The input device 408 may include, for example, a keyboard, a keypad, a mouse, or a touchscreen. Each of these output devices 406 and input device 408 may be joined by one or more additional peripherals.

A network communicator 410 may be provided to connect the computer system to a network and in turn to other devices connected to the network including other entities, servers, data stores, and interfaces. The network communicator 410 may include, for example, a network adapter such as a LAN adapter or a wireless adapter. The computer system may include a data sources interface 412 to access a data source 414. The data source 414 may be an information resource about the one or more AI models. As an example, the one or more databases 104 of exceptions and rules may be provided as the data source 414. Moreover, knowledge repositories and curated data may be other examples of the data source 414. The data source 414 may include libraries containing, but not limited to, datasets related to the one or more AI models, the AI model configurations, historical data, and other essential information. Moreover, the data sources interface 412 enables the system 102 to dynamically access and update these data repositories as new information is collected, analyzed, and utilized

Numerous advantages of the present disclosure may be apparent from the discussion above. In accordance with the present disclosure, the system for evaluating the operational performance to optimize the one or more AI models provides a comprehensive, automated, and adaptive risk assessment framework that enhances the one or more AI models reliability, fairness, security, and compliance. The system leverages real-time monitoring, structured assurance scoring, and dynamic compliance mapping to ensure that the one or more AI models continuously align with evolving regulatory standards and industry best practices. By integrating advanced evaluation techniques, including the semantic similarity analysis, the X-Encoder contextual modeling, the retrieval-augmented generation (RAG), the token-based Shapley approximation, and adversarial attack detection, the system delivers precise, explainable, and transparent AI risk assessments that enable informed decision-making.

One of the key technical advantages of the system is its scalability and adaptability across multiple deployment environments, including the on-premise servers, the cloud-based platforms, the edge computing devices, and the hybrid infrastructures. This ensures that the one or more AI models maintain consistent performance and compliance regardless of their operational environment. The automated assurance scoring mechanism, based on weighted scoring procedures, allows the system to dynamically adjust risk evaluations based on the intended application, domain-specific requirements, and real-time feedback, ensuring context-aware and domain-adaptive governance. The system also provides robust security assessments by detecting vulnerabilities such as adversarial attacks, prompt injection risks, and unauthorized data exposure, mitigating potential threats before they impact the one or more AI model performance.

Another significant advantage is the system's continuous monitoring and adaptive risk mitigation capabilities, which allow the one or more AI models to undergo iterative improvements, real-time anomaly detection, and proactive compliance adjustments. By integrating the expert-reviewed threshold validation, the historical risk benchmarking, and the drift detection models, the system ensures that AI models remain resilient to performance degradation and evolving risk factors. The system's dynamic control recommendation subsystem enables automated governance interventions, including design stage controls, development and training refinements, deployment security reinforcements, and live fine-tuning mechanisms, ensuring that the one or more AI models operate within ethical, secure, and legally compliant boundaries.

Furthermore, the system enhances the one or more AI models explainability and transparency through structured explanation frameworks, chain-of-thought reasoning mechanisms, and token-level contribution analysis, fostering greater trust, accountability, and regulatory acceptance of AI-driven decisions. By providing a standardized yet flexible AI risk governance solution, the system ensures that organizations may deploy the one or more AI models confidently, maintain regulatory adherence, and uphold ethical AI principles across diverse industries and operational landscapes.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words "comprising," "having," "containing," and "including," and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

What is claimed is:

1. A computer-implemented method for evaluating operational performance to optimize one or more artificial intelligence (AI) models, comprising:
obtaining, by one or more hardware processors through a model functionality profiling subsystem, structured information associated with the one or more artificial intelligence (AI) models from at least one of: one or more users and one or more internal frameworks;
evaluating, by the one or more hardware processors through a model evaluating subsystem, assurance scores of one or more assurance parameters based on an intended functionality of the one or more artificial intelligence (AI) models using at least one of: one or more large language models (LLMs), one or more machine learning (ML) models, a retrieval-augmented generation (RAG) framework, a chain-of-thought reasoning framework, a comparative analysis procedure, and a semantic similarity analysis;
generating, by the one or more hardware processors through an aggregate assurance score generating subsystem, an aggregate assurance score for the one or more artificial intelligence (AI) models based on aggregating the assurance scores using weighted scoring procedures based on at least one of: severity and probability of deviations in the operational performance the one or more artificial intelligence (AI) models;
performing, by the one or more hardware processors through a score validation subsystem, a comparative analysis between the aggregate assurance score and at least one of: predefined industry benchmarks, historical risk incidents, and expert-reviewed threshold data to validate the generated aggregate assurance score;
mapping, by the one or more hardware processors through a compliance mapping subsystem, the validated aggregate assurance score with one or more artificial intelligence (AI) compliance standards to determine contrary compliance data based on deviations in the aggregate assurance score from predefined regulatory threshold scores;
providing, by the one or more hardware processors through a dynamic control recommendation subsystem, one or more recommendation controls to the one or more users based on detected changes in at least one of: an artificial intelligence (AI) model architecture, training data in real-time, to mitigate the determined contrary compliance data; and
evaluating, by the one or more hardware processors through a continuous monitoring subsystem, the operational performance of the one or more artificial intelligence (AI) models in real-time based on detection of updated structured information in the one or more artificial intelligence (AI) models over a defined time period to optimize the one or more artificial intelligence (AI) models.

2. The computer-implemented method of claim 1, wherein the structured information comprises at least one of:
meta data comprising at least one of: functional information, intended application data, input data, and output data, associated with the one or more artificial intelligence (AI) models from the one or more users;
tooling information comprising at least one of: computer program frameworks, model training tools, a plurality of deployment infrastructures, monitoring tools, and third-party application programming interface (API) integrations used in at least one of: development, deployment, and operation, of the one or more artificial intelligence (AI) models from at least one of: the one or more users and the one or more internal frameworks;
technical information comprising at least one of: artificial intelligence (AI) model architecture, underlying process, training methodologies, fine-tuning processes, hyperparameters, and dependency mappings relevant to functioning of the one or more artificial intelligence (AI) models;
resource allocation information comprising at least of: processor type, memory allocation, storage capacity, network bandwidth, graphics processing unit (GPU) usage, cloud deployment settings, on-premise deployment settings, and associated cost parameters required for training, inference, and operational execution of the one or more artificial intelligence (AI) models;
dependency mapping information comprising at least one of: internal dependencies including database connections, internal application programming interface (API), and proprietary datasets, and external dependencies including third-party application programming interface (API), cloud services, and open-source libraries used in the operational execution of the one or more artificial intelligence (AI) models;
data governance information comprising at least of: responsibility matrix data, and accountability structure data; and
data usage information comprising at least of: data set inventories, and data governance controls.

3. The computer-implemented method of claim 1, wherein the one or more assurance parameters comprise at least one of: bias parameters, fairness parameters, transparency parameters, privacy parameters, profanity parameters, security parameters, compliance parameters, accuracy parameters, reliability parameters, safety parameters, and accessibility parameters.

4. The computer-implemented method of claim 1, wherein evaluating the assurance scores comprising at least one of:
determining a bias score using the one or more large language models (LLMs) trained on biased datasets, based on an analysis of the biased datasets and the generated output data to identify statistical imbalances in decision-making;
computing a fairness score as an inverse function of the bias score to quantify the one or more artificial intelligence (AI) models ability to provide unbiased and equitable outcomes;
computing a transparency score using at least one of:
the retrieval-augmented generation (RAG) framework employing structured prompts, cosine similarity scoring, and token-based Shapley approximation to evaluate explainability; and
the chain-of-thought reasoning framework to assess the output data generated by the one or more artificial intelligence (AI) models to provide step-by-step justifications;
identifying profanity data in the output data of the one or more artificial intelligence (AI) models using the one or more machine learning (ML) models trained on pre-defined profanity data for generating a profanity score;
evaluating a security score based on detection of vulnerabilities in the output data of the one or more artificial intelligence (AI) models, at least one of: adversarial attacks, prompt injection risks, and unauthorized data exposure, using a security assessment framework;
mapping the validated aggregate assurance score with at least one of: the one or more artificial intelligence (AI) compliance standards to determine a compliance percentage;
determining an accuracy score using a dual evaluation, comprising:
the semantic similarity analysis to compare the output data of the one or more artificial intelligence (AI) models against an expected output; and
an X-Encoder module configured to capture intricate contextual relationships between the input data and the output data of the one or more artificial intelligence (AI) models; and
computing a reliability score based on analyzing multiple response data generated for a single input data using at least one of: a sentence transformer model, a pairwise cosine similarity matrix.

5. The computer-implemented method of claim 1, wherein evaluating the assurance scores of the one or more assurance parameters comprise:
deploying the one or more artificial intelligence (AI) models on the plurality of deployment infrastructures, including at least one of: on-premise servers, cloud-based platforms, edge computing devices, and hybrid environments, to assess the operational performance across the plurality of deployment infrastructures to evaluate the assurance scores of one or more assurance parameters consistently.

6. The computer-implemented method of claim 1, wherein generating the aggregate assurance score using the weighted scoring procedures further comprises:
providing a weighted score to each assurance parameter of the one or more assurance parameters based on the severity and the probability of deviations in the operational performance of the one or more artificial intelligence (AI) models;
dynamically altering the weighted score of the one or more assurance parameters based on at least one of: the intended application, application domain, and real-time monitoring feedback of the one or more artificial intelligence (AI) models;
normalizing the weighted score of the one or more assurance parameters across the plurality of deployment infrastructures to perform a comparative evaluation to generate the aggregate assurance score; and
categorizing the aggregate assurance score into a plurality of stages based on the predefined regulatory threshold scores to determine the operational performance of the one or more artificial intelligence (AI) models.

7. The computer-implemented method of claim 1, wherein performing the comparative analysis of the aggregate assurance score further comprises:
determining degradation of the one or more artificial intelligence (AI) models over a time period based on the comparative analysis between the aggregate assurance score and the predefined industry benchmarks using at least one of: drift detection models and variance analysis procedures;
identifying inconsistencies in the assurance scores of one or more assurance parameters based on the comparative analysis between real-time assurance scores and the historical risk incidents; and
obtaining the expert-reviewed threshold data from at least one of: the one or more users and one or more consultant experts to perform the comparative analysis between the aggregate assurance score and the expert-reviewed threshold data to validate the mapping of the aggregate assurance score to the one or more artificial intelligence (AI) compliance standards.

8. The computer-implemented method of claim 1, wherein the one or more recommendation controls comprise at least one of: design stage controls, development and training controls, deployment controls, monitoring and operational controls, and live fine-tuning controls, to mitigate the determined contrary compliance data.

9. The computer-implemented method of claim 1, wherein evaluating the operational performance by the continuous monitoring subsystem further comprises:
identifying the contrary compliance data across the one or more artificial intelligence (AI) compliance standards to prioritize one or more compliance requirements based on the assurance scores of the one or more assurance parameters;
generating an analysis data comprises at least one of: compliance deviations, remediation actions, and aggregate assurance score justifications of the one or more artificial intelligence (AI) models; and
adapting compliance mappings dynamically based on updated one or more artificial intelligence (AI) compliance standards.

10. A computer-implemented system for evaluating operational performance to optimize one or more artificial intelligence (AI) models, comprising:
one or more hardware processors; and
a memory unit operatively connected to the one or more hardware processors, wherein the memory unit comprises a set of computer-readable instructions in form of a plurality of subsystems, configured to be executed by the one or more hardware processors, wherein the plurality of subsystems comprises:
a model functionality profiling subsystem configured to obtain structured information associated with the one or more artificial intelligence (AI) models from at least one of: one or more users and one or more internal frameworks;
a model evaluating subsystem configured to evaluate assurance scores of one or more assurance parameters based on an intended functionality of the one or more artificial intelligence (AI) models using at least one of: one or more large language models (LLMs), one or more machine learning (ML) models, a retrieval-augmented generation (RAG) framework, a chain-of-thought reasoning framework, a comparative analysis procedure, and a semantic similarity analysis;
an aggregate assurance score generating subsystem configured to generate an aggregate assurance score for the one or more artificial intelligence (AI) models based on aggregating the assurance scores using weighted scoring procedures based on at least one of: severity and probability of deviations in the operational performance the one or more artificial intelligence (AI) models;
a score validation subsystem configured to perform a comparative analysis between the aggregate assurance score and at least one of: predefined industry benchmarks, historical risk incidents, and expert-reviewed threshold data to validate the generated aggregate assurance score;
a compliance mapping subsystem configured to map the validated aggregate assurance score with one or more artificial intelligence (AI) compliance standards to determine contrary compliance data based on deviations in the aggregate assurance score from predefined regulatory threshold scores;
a dynamic control recommendation subsystem configured to provide one or more recommendation controls to the one or more users based on detected changes in at least one of: an artificial intelligence (AI) model architecture, training data in real-time, to mitigate the determined contrary compliance data; and
a continuous monitoring subsystem configured to evaluate the operational performance of the one or more artificial intelligence (AI) models in real-time based on detection of updated structured information in the one or more artificial intelligence (AI) models over a defined time period for optimizing the one or more artificial intelligence (AI) models.

11. The computer-implemented system of claim 10, wherein the structured information comprises at least one of:
meta data comprising at least one of: functional information, intended application data, input data, and output data, associated with the one or more artificial intelligence (AI) models from the one or more users;
tooling information comprising at least one of: computer program frameworks, model training tools, a plurality of deployment infrastructures, monitoring tools, and third-party application programming interface (API) integrations used in at least one of: development, deployment, and operation, of the one or more artificial intelligence (AI) models from at least one of: the one or more users and the one or more internal frameworks;
technical information comprising at least one of: artificial intelligence (AI) model architecture, underlying process, training methodologies, fine-tuning processes, hyperparameters, and dependency mappings relevant to functioning of the one or more artificial intelligence (AI) models;
resource allocation information comprising at least of: processor type, memory allocation, storage capacity, network bandwidth, graphics processing unit (GPU) usage, cloud deployment settings, on-premise deployment settings, and associated cost parameters required for training, inference, and operational execution of the one or more artificial intelligence (AI) models;
dependency mapping information comprising at least one of: internal dependencies including database connections, internal application programming interface (API), and proprietary datasets, and external dependencies including third-party application programming interface (API), cloud services, and open-source libraries used in the operational execution of the one or more artificial intelligence (AI) models;
data governance information comprising at least of: responsibility matrix data, and accountability structure data; and
data usage information comprising at least of: data set inventories, and data governance controls.

12. The computer-implemented system of claim 10, wherein the one or more assurance parameters comprise at least one of: bias parameters, fairness parameters, transparency parameters, privacy parameters, profanity parameters, security parameters, compliance parameters, accuracy parameters, reliability parameters, safety parameters, and accessibility parameters.

13. The computer-implemented system of claim 10, wherein the assurance scores comprise at least one of:
a bias score determined using the one or more large language models (LLMs) trained on biased datasets, based on an analysis of the biased datasets and the generated output data to identify statistical imbalances in decision-making;
a fairness score is computed as an inverse function of the bias score to quantify the one or more artificial intelligence (AI) models ability to provide unbiased and equitable outcomes;
a transparency score is computed using at least one of:
the retrieval-augmented generation (RAG) framework employing structured prompts, cosine similarity scoring, and token-based Shapley approximation to evaluate explainability; and
the chain-of-thought reasoning framework to assess the output data generated by the one or more artificial intelligence (AI) models to provide step-by-step justifications;
a profanity score is generated by identifying profanity data in the output data of the one or more artificial intelligence (AI) models using the one or more machine learning (ML) models trained on pre-defined profanity data;
a security score is evaluated based on detection of vulnerabilities in the output data of the one or more artificial intelligence (AI) models, at least one of: adversarial attacks, prompt injection risks, and unauthorized data exposure, using a security assessment framework;
a compliance percentage is determined by mapping the validated aggregate assurance score with at least one of: the one or more artificial intelligence (AI) compliance standards;
an accuracy score is determined using a dual evaluation, comprising:
the semantic similarity analysis to compare the output data of the one or more artificial intelligence (AI) models against an expected output; and
an X-Encoder module configured to capture intricate contextual relationships between the input data and the output data of the one or more artificial intelligence (AI) models; and
a reliability score is computed based on analyzing multiple response data generated for a single input data using at least one of: a sentence transformer model, a pairwise cosine similarity matrix.

14. The computer-implemented system of claim 10, wherein the model evaluating subsystem is configured to deploy the one or more artificial intelligence (AI) models on the plurality of deployment infrastructures for assessing the operational performance across the plurality of deployment infrastructures to evaluate the assurance scores of one or more assurance parameters consistently,
the plurality of deployment infrastructures include at least one of: on-premise servers, cloud-based platforms, edge computing devices, and hybrid environments.

15. The computer-implemented system of claim 10, wherein the aggregate assurance score generating subsystem using the weighted scoring procedures is configured to:
provide a weighted score for each assurance parameter of the one or more assurance parameters based on the severity and the probability of deviations in the operational performance of the one or more artificial intelligence (AI) models;
dynamically alter the weighted score of the one or more assurance parameters based on at least one of: the intended application, application domain, and real-time monitoring feedback of the one or more artificial intelligence (AI) models;
normalize the weighted score of the one or more assurance parameters across the plurality of deployment infrastructures to perform a comparative evaluation to generate the aggregate assurance score; and
categorize the aggregate assurance score into a plurality of stages based on the predefined regulatory threshold scores to determine the operational performance of the one or more artificial intelligence (AI) models.

16. The computer-implemented system of claim 10, wherein the score validation subsystem is configured to:
determine degradation of the one or more artificial intelligence (AI) models over a time period based on the comparative analysis between the aggregate assurance score and the predefined industry benchmarks using at least one of: drift detection models and variance analysis procedures;
identify inconsistencies in the assurance scores of one or more assurance parameters based on the comparative analysis between real-time assurance scores and the historical risk incidents; and
obtain the expert-reviewed threshold data from at least one of: the one or more users and one or more consultant experts to perform the comparative analysis between the aggregate assurance score and the expert-reviewed threshold data to validate the mapping of the aggregate assurance score to the one or more artificial intelligence (AI) compliance standards.

17. The computer-implemented system of claim 10, wherein the one or more recommendation controls comprise at least one of: design stage controls, development and training controls, deployment controls, monitoring and operational controls, and live fine-tuning controls, to mitigate the determined contrary compliance data.

18. The computer-implemented system of claim 10, wherein the continuous monitoring subsystem is configured to:
identify the contrary compliance data across the one or more artificial intelligence (AI) compliance standards to prioritize one or more compliance requirements based on the assurance scores of the one or more assurance parameters;
generate an analysis data comprises at least one of: compliance deviations, remediation actions, and aggregate assurance score justifications of the one or more artificial intelligence (AI) models; and
adapt compliance mappings dynamically based on updated one or more artificial intelligence (AI) compliance standards.

19. A non-transitory computer-readable storage medium storing computer-executable instructions that, when executed by one or more hardware processors, cause the one or more hardware processors to perform operations for evaluating operational performance to optimize one or more artificial intelligence (AI) models, the operations comprising:
obtaining structured information associated with the one or more artificial intelligence (AI) models from at least one of: one or more users and one or more internal frameworks;
evaluating assurance scores of one or more assurance parameters based on an intended functionality of the one or more artificial intelligence (AI) models using at least one of: one or more large language models (LLMs), one or more machine learning (ML) models, a retrieval-augmented generation (RAG) framework, a chain-of-thought reasoning framework, a comparative analysis procedure, and a semantic similarity analysis;
generating an aggregate assurance score for the one or more artificial intelligence (AI) models based on aggregating the assurance scores using weighted scoring procedures based on at least one of: severity and probability of deviations in the operational performance the one or more artificial intelligence (AI) models;
performing a comparative analysis between the aggregate assurance score and at least one of: predefined industry benchmarks, historical risk incidents, and expert-reviewed threshold data to validate the generated aggregate assurance score;
mapping the validated aggregate assurance score with one or more artificial intelligence (AI) compliance standards to determine contrary compliance data based on deviations in the aggregate assurance score from predefined regulatory threshold scores;
providing one or more recommendation controls to the one or more users based on detected changes in at least one of: an artificial intelligence (AI) model architecture, training data in real-time, to mitigate the determined contrary compliance data; and
evaluating the operational performance of the one or more artificial intelligence (AI) models in real-time based on detection of updated structured information in the one or more artificial intelligence (AI) models over a defined time period to optimize the one or more artificial intelligence (AI) models.

20. The non-transitory computer-readable storage medium of claim 19, wherein the structured information comprises at least one of:
meta data comprising at least one of: functional information, intended application data, input data, and output data, associated with the one or more artificial intelligence (AI) models from the one or more users;
tooling information comprising at least one of: computer program frameworks, model training tools, a plurality of deployment infrastructures, monitoring tools, and third-party application programming interface (API) integrations used in at least one of: development, deployment, and operation, of the one or more artificial intelligence (AI) models from at least one of: the one or more users and the one or more internal frameworks;
technical information comprising at least one of: artificial intelligence (AI) model architecture, underlying process, training methodologies, fine-tuning processes, hyperparameters, and dependency mappings relevant to functioning of the one or more artificial intelligence (AI) models;
resource allocation information comprising at least of: processor type, memory allocation, storage capacity, network bandwidth, graphics processing unit (GPU) usage, cloud deployment settings, on-premise deployment settings, and associated cost parameters required for training, inference, and operational execution of the one or more artificial intelligence (AI) models;
dependency mapping information comprising at least one of: internal dependencies including database connections, internal application programming interface (API), and proprietary datasets, and external dependencies including third-party application programming interface (API), cloud services, and open-source libraries used in the operational execution of the one or more artificial intelligence (AI) models;
data governance information comprising at least of: responsibility matrix data, and accountability structure data; and
data usage information comprising at least of: data set inventories, and data governance controls.
